(19) United States
(12) Patent Application Publication
(10) Pub. No.: US 2008/0046603 A1
(43) Pub. Date: Feb. 21, 2008

(54) Line Diagnostic Device, Bus System, Line Diagnostic Method, Bus System Control Method, and Line Diagnostic Program

(76) Inventors: Eiji Kobayashi, Hitachinaka (JP); Akira Bandou, Hitachi (JP); Masamitsu Kobayashi, Hitachi (JP); Masahiro Shiraishi, Hitachi (JP); Akihiro Onozuka, Hitachi (JP); Takashi Umehara, Hitachi (JP); Shin Kokura, Hitachi (JP); Masakazu Ishikawa, Hitachi (JP); Yasuyuki Furuta, Naka (JP); Satoru Funaki, Hitachi (JP); Yuusuke Seki, Hitachi (JP); Tatsuyuki Ootani, Hitachi (JP); Teruaki Sakata, Hitachi (JP); Kotaro Shimamura, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/769,789

(22) Filed: Jun. 28, 2007

(30) Foreign Application Priority Data
Jun. 30, 2006 (JP) 2006-180649
Sep. 1, 2006 (JP) 2006-237710

(51) Int. Cl. G06F 3/00

(52) U.S. Cl. 710/17

(57) ABSTRACT

A control device diagnoses the operation of a bus arbiter that mediates bus usage requests output by multiple devices in the control device to satisfy both responsiveness and safety. A diagnostic module, implemented as an external diagnostic module, monitors signals related to the arbiter mediation and, if an abnormality caused by a signal sticking condition or an abnormality in a mediation control unit is detected, stops data transfer safely to prevent safety data from being output incorrectly.

### BACKGROUND OF THE INVENTION

1. Field of the Invention

The present invention relates to a line diagnostic device, a bus system, a line diagnostic method, a bus system control method, and a line diagnostic program, and more particularly to a line diagnostic device, a bus system, a line diagnostic method, a bus system control method, and a line diagnostic program that are suitable for ensuring safety.

2. Description of Related Art

Recent advances in the bus arbiter technology for mediating competition for mastership on the common bus are remarkable. Especially, the data transfer speed of a common bus used for a PC system, such as a PCI bus or an ISA bus, is rapidly increasing and, to guarantee the operation of the system, a bus arbiter for mediating multiple bus masters is required.

The operation of the bus arbiter is executed by mediation means that selects one bus master from multiple bus masters, each of which issues a bus usage right request, and grants the bus usage right to the selected bus master. The selected bus master acquires the bus usage right for transferring data to the bus. In general, the arbiter-based mediation is executed by inputting and outputting the bus-usage-right requesting REQ signal and the bus-usage-right granting GNT signal between the masters and the arbiter as in the PCI bus. To mediate requests, the arbiter mediates the REQ signals, issued from multiple masters, according to a predetermined mediation algorithm and outputs the GNT signal to one master. A technology for a bus arbiter is disclosed, for example, in JP-A-2003-099395 (See Patent Document 1).

In a system, such as a plant, a railway, and a plane, where extremely high reliability is required to protect the safety of human beings and environment, the failsafe mechanism is required to keep the whole system safe without adverse effects on others even if a system failure or a system error occurs.

Such a system tends to employ more and more electronic devices to perform sophisticated control operations and this tendency, in turn, requires higher reliability of the electronic devices.

Safety that is based on the assumption that the devices operate properly is called functional safety. Recently, the IEC (International Electrotechnical Commission) 61508 standard is constituted to define the objective level of the functional safety of a system that uses electronic devices. To implement a system that satisfies this level, various reliability mechanisms must be included into all constituent hardware and software parts.

For example, in a power generation plant system, the control unit receives an instruction from a control terminal and sends the received instruction to an I/O device to run the power generation plant. A failure or an error, if generated in the control device controlling those I/O devices, may endanger the controlled power generation plant. To prevent this situation, various types of failsafe mechanisms are included.

In the bus system part in this control device where two masters A and B and multiple slaves A and B are connected via the bus, master A or B sends data to the slaves A and B to perform control processing. To increase the reliability of the control device including the bus, each component of the transmission system composed of masters A and B, slaves A and B, and the bus is duplicated. In this redundant configuration, data is compared between the two transmission systems to detect an error and, if a mismatch is found, the system is safely migrated or stopped. Although a dual system like this is used in many fields, the problem is that the system configuration cost and the power consumption are several times as high as those of a standard non-dual system.

To solve this problem, the following configuration is sometimes built. That is, one-bit parity signal is added to the bus, and the parity check unit is added to the masters and the slaves. Each parity check unit adds a one-bit parity to data that is sent to the bus and, when data is received from the bus, checks the one-bit parity to see if the transferred data is correct. This checking increases the reliability of data transferred via the bus. Instead of the parity signal, the error correction code or the cyclic redundancy check code is also used in many cases.

During the control operation, data is not always required to be transferred among all multiple masters and multiple salves. To transfer data between a particular master and a particular slave, JP-A-11-328383 discloses a configuration in which a bus switch, selectively turned on and off, is provided in the connection part between a slave and a bus. JP-A-2005-276136 discloses another configuration in which a master and a slave are connected via a data transfer path generated by dividing the bus via a bus switch. During a data transfer between a master and a slave, this configuration allows another master and another slave, not involved in the data transfer, to transfer data via another data transfer path in the same bus.

In the control field having a control device, many systems are built using this arbiter technology. For example, when multiple plug-ins each having the arbiter function are provided on the backplane of a control device rack mounted on the control panel in a control plant and the multiple plug-ins, which act as bus masters, control the input/output of control objects, data is read from, and written into, the bus masters via the common bus. Especially, in the field of control where responsiveness is required, the arbiter operation is required to quickly switch the mediation of bus masters when a large amount of data is transferred, including a large amount of communication data transferred from multiple bus masters, to allow the online software processing operation to keep running at a constant speed. This requires quick switching between the data transfer and the mediation. The bus used in this case is either a unique bus or a current mainstream general system bus such as the PCI bus.

On the other hand, it is highly possible, from the nature of the device and the system, that not only a control device used in a mission critical control field is responsible for controlling and protecting devices via data input/output to or from control objects but also the operation of a control device is related to the safety of devices of the controlled objects (process side) and to the protection of human beings. This possibility leads to the high requirements for the safety of the system and the control device that controls the system. One of the responses to those requirements is IEC61508, an international standard for the functional safety, that is beginning to be applied to a control device across the world. This functional safety standard IEC61508 includes the definition of the safety requirements for a bus arbiter. Satisfying those safety requirements enables a control device to attain a predetermined safety level.

To prevent a control device from performing dangerous operations, the functional safety requires that the main functions be diagnosed. The standard also requires that the arbiter operation, which is the core operation on the bus, be diagnosed. When the central processing unit, which processes safety data and outputs the processed data to a process based on data entered from a controlled object (process side), acts as a bus master and transfers the safety data to the bus, it is required that the safety-related data does not affect the safety operation when an incorrect output is sent to, or an incorrect operation is performed on, a controlled object. Even when the arbiter operates incorrectly, it is necessary to detect the error and to stop outputting the safety data to a process within the reaction time in order to prove that the safety data is not destroyed and that the safety data is not output incorrectly to a controlled object.

Various diagnostic methods are proposed as a technology for increasing the safety of a control device. The diagnosis rate can be increased by diagnosing the microprocessor, bus, memory, ASIC, and input/output. However, those diagnoses are sometimes insufficient to cover the failure mode (abnormality) that may occur on the bus arbiter, and the arbiter function must be diagnosed to further increase the diagnosis rate.

First, the possible failure mode of an arbiter includes a malfunction caused by the signal sticking of the bus request signal REQ and the bus grant signal GNT and an arbiter malfunction generated by a function error caused by an error in the functions in the arbiter such as the mediation operation function and the status control function. When any of those errors is generated and there is a failure mode that is not detected but may lead to a dangerous operation, it is necessary to check if safety data is transferred safely. Thus, diagnosing a failure mode described above that may affect the transfer of safety data is necessary to increase the safety of a control device.

One of the diagnostic methods is the software-based diagnosis of the arbiter operation. The advantage of the software-based diagnosis is that the arbiter can be diagnosed relatively flexibly by the diagnostic operation executed via a diagnostic pattern created by the microprocessor, while the disadvantage is that the creation of the diagnostic processing program requires manpower and that the diagnostic processing during the online operation takes long. Especially, the disadvantage described above requires the interruption of data transfer during the real time operation where responsiveness and high-speed operation are required, thus resulting that safety data cannot be transferred regularly and timely. This may lead to a fatal performance problem in the online real-time processing where speedy control operations are required.

Another problem is that an arbiter is usually built as a custom LSI (ASIC) and the circuit for diagnosing the arbiter is sometimes built as the hardware logic in the same LSI. In this case, if an error occurs, it is difficult to identify the scope of the error. Therefore, if an error occurs in the arbiter, it is necessary to verify that the diagnostic circuit in the same LSI for diagnosing the arbiter functions correctly.

It is one of the objects of the present invention to provide a diagnostic device, a line diagnostic method, and a line diagnostic program that can solve at least one of the problems described above.

For example, if a slave not involved in the transfer fails while a master is transferring data to another slave, the failed slave may improperly send incorrect data to the bus and the bus data become disturbed. If only one bit of the bus data signal is affected by the bus data disturbance, the error may be detected by the parity signal and the parity check. However, if two or more bits are changed at a time or if all data transferred from the master to the salve is overwritten by the data sent from the failed slave, the error cannot be detected by the parity or the error correction code. If the data transferred at that time is important data related to the functional safety of the system, the system may enter the dangerous state.

The method disclosed in JP-A-11-328383 is that, while data is transferred to a specific slave via the bus, processing is performed between each of the other slaves and its own local memory. However, there is no means for the system to check if the data is related to the functional safety. Therefore, after the data is transferred, the salve is disconnected from the bus and the processing is performed between the slave and the local memory. This means that the slave side cannot perform the functional safety processing and, in addition, there is no means for maintaining the safety of the device and the system when the master or the salve fails or the bus switch fails. The document does not describe what status will occur in this case.

The device disclosed in JP-A-2005-276136 does not have means for checking if the data is related to the functional safety. The document does not disclose means for maintaining the safety when the master or a slave fails or a bus switch fails.

It is one of the objects of the present invention to provide a reliable bus system that can prevent a failure, which occurs in a part not related to the transfer of priority data during its transfer, from affecting the transfer of the priority data.

### SUMMARY OF THE INVENTION

To achieve the above object, the present invention provides a line diagnostic device comprising a mediation control unit that sends and receives a usage right mediation signal of a second communication line via a first communication line wherein information on a controlled object is sent and received via the second communication line; and a diagnosis unit that monitors signals on the first communication line for checking for an abnormality in the mediation unit, wherein, if an abnormality is found in the mediation unit, the diagnosis unit outputs a signal for suppressing a communication on the second communication line.

To increase the diagnosis rate of a control device itself, the present invention does not rely on a technology for diagnosing the bus, which is a data transfer path, and on the diagnosis by a microprocessor but provides an external diagnostic device having the arbiter function diagnosis means to cause this device to safely stop the output of data when an arbiter abnormality is detected.

According to the present invention, the “line diagnostic device” is a diagnostic device configured as a part separate from the system LSI containing the arbiter. The device monitors the bus right request REQ signal output from bus masters to the arbiter, the bus right grant GNT signal output from the arbiter to the bus masters, and the signals related to other arbiter operations to diagnose the arbiter operation.

The diagnostic device monitors the signals in the mediation period before the bus transfer cycle during the online operation. As described above, to solve the problem of performance degradation involved in the software-based arbiter operation diagnosis, the diagnostic device performs hardware-based monitoring in the mediation period to prevent the data transfer from being interrupted. Monitoring the output status of the bus right grant GNT signal in the monitoring time period makes it possible to detect whether the arbiter operation is normal or abnormal. Normally, the effective bus right grant signal should not be output during the mediation period to multiple bus masters. If the bus right grant signal is issued to multiple bus masters, it is possible that a signal sticking condition occurs or a bus right grant GNT signal generation unit in the arbiter fails. In this case, the diagnostic device can monitor the bus right grant GNT signal to diagnose the arbiter function. If multiple bus right grant GNT signals are output, multiple bus masters, which incorrectly identify that they have received the bus right, may output data to the bus with the result that a data conflict may occur. Such a situation, if generated while safety data is being transferred, destroys the safety data. Therefore, the diagnostic device has means that, when this abnormality is detected, protects the safety data immediately and outputs a stop instruction to the bus control unit to stop the data safely.

The monitoring means described above is an example, and there are other monitoring methods. Embodiments of the present invention describe means for increasing the diagnosis rate of the arbiter and the means for testing the diagnostic device from an external microprocessor on a software basis. Those means are implemented by monitoring the state transition of the arbiter, by monitoring the bus SW control signal on/off status that changes with the safety data transfer status signal on the line, and by monitoring the GNT signal.

A bus system in which one or more masters and a plurality of slaves are connected to a bus via bus switches for transferring data between the masters and the slaves comprises a first data transfer period specification unit provided in the master for specifying a transfer period of first data; and a switch control unit that, when the transfer period of the first data is specified, sets the bus switches, corresponding to the master and the slave between which the first data is transferred, to ON and, sets the bus switches, corresponding to the master and the slave not related to the transfer of the first data, to OFF.

In a preferred embodiment of the present invention, when there are two types of transfer data in a target system, the transfer of the first data is a transfer of data to which priority should be given.

In a preferred embodiment of the present invention, the transfer of the first data is a transfer of data necessary for maintaining the safety operation of a target system.

In a preferred embodiment of the present invention, the first data is data related to the basic function of a target system and the other transfer data is data related to the auxiliary function the target system.

For example, in a power generation plant, data related to the power generation plant control function is data related to the basic function of the target system and data for use by a control monitor that monitors and displays the operation status of the power generation plant is data related to the auxiliary function of the power plant system to be diagnosed.

The present invention satisfies the requirements for the responsiveness and for the safety of data transfer and mediation control operation without decreasing the transfer performance, thus increasing the safety of the whole control device. More specifically, the diagnostic device, configured by a part different from the arbiter, provides means for monitoring the timing of data transfer during an online operation for diagnosing an arbiter operation abnormality, not through software diagnostic processing, but on a hardware basis. This diagnostic device satisfies the requirement for the responsiveness of data transfer and for the safety of the mediation control operation without performance degradation due to a failure in the data transfer on the line, thus increasing the safety of the whole control device.

The present invention provides bus switches between the bus and the masters and between the bus and slaves and, during the transfer of first data, disconnects the master and the slave, not related to the transfer, from the bus. This configuration reduces failures generated in the transfer of data on the bus.

This configuration implements a reliable bus system that reliably transfers priority data simply by adding low-cost improvements to an existing bus system without duplicating the bus and the circuits.

Other objects and features of the present invention will be made more apparent by the description of embodiment described below.

### BRIEF DESCRIPTION OF THE DRAWINGS

FIG. 1 is a diagram showing the general configuration of a line diagnostic device.

FIG. 2 is a diagram showing the internal configuration of the line diagnostic device.

FIG. 3 is a diagram showing the status transition and the operation timing at a normal operation time.

FIG. 4 is a diagram showing a software-based mediation control unit and its diagnosis execution.

FIG. 5 is a diagram showing a first embodiment of the line diagnostic device (1-1).

FIG. 6 is a diagram showing the first embodiment of the line diagnostic device (1-2).

FIG. 7 is a diagram showing a second embodiment of the line diagnostic device (2-1).

FIG. 8 is a diagram showing the second embodiment of the line diagnostic device (2-2).

FIG. 9 is a diagram showing a third embodiment of the line diagnostic device (3-1).

FIG. 10 is a diagram showing a fourth embodiment of the line diagnostic device (4-1).

FIG. 11 is a diagram showing the fourth embodiment of the line diagnostic device (4-2).

FIG. 12 is a diagram showing the fourth embodiment of the line diagnostic device (4-3).

FIG. 13 is a block diagram showing the configuration of a bus system in a fifth embodiment of the present invention and showing the states of bus switches when priority (safety) data is transferred.

FIG. 14 is a block diagram showing a switch control unit in the bus system.

FIG. 15 is a timing diagram when priority (safety) data is transferred in the bus system.

FIG. 16 is a block diagram showing the configuration of the bus system and showing the states of bus switches when non-priority (ordinary) data is transferred.

FIG. 17 is a timing diagram when non-priority (ordinary) data is transferred in the bus system.

FIG. 18 is a block diagram showing a bus system having a function to diagnose a bus switch OFF sticking condition in a sixth embodiment of the present invention.

FIG. 19 is a detailed block diagram showing a switch control unit.

FIG. 20 is a block diagram showing a bus system having a mechanism to diagnose a bus switch ON sticking condition.

FIG. 21 is a timing diagram showing the flow of the bus system and switch diagnostic processing FIGS. 22A, 22B, and 22c are diagrams showing examples of the configuration of transistor cells used in a bus switch.

FIG. 23 is a diagram showing the block configuration in which the bus system is applied to a power generation plant.

FIG. 24 is a diagram showing the block configuration in which the bus system is applied to a car.

FIG. 25 is a diagram showing the block configuration in which the bus system is applied to a multi-function mobile phone.

### DETAILED DESCRIPTION OF THE EMBODIMENTS

Embodiments of the present invention will be described below.

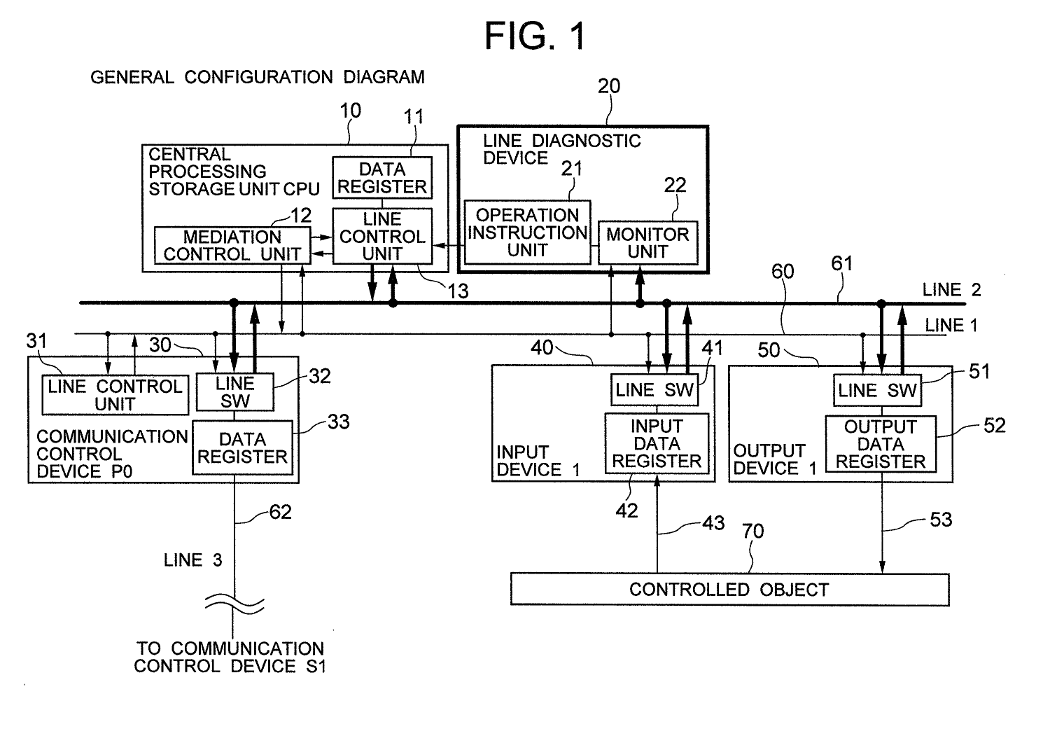

FIG. 1 shows an example of the general configuration of a control device in which a line diagnostic device according to the present invention is used. The control device comprises a central processing storage unit CPU 10 connected by a line 2 that is a data transfer path, a communication control device P0 30 that controls the communication, and an input device 1 40 and an output device 1 50 that are an interface with a controlled object.

The following describes the basic operation of the control device. The central processing storage unit CPU 10 transfers data to and from a data register 33 in the communication control device P0 30 via a line 2 61. The transmission/reception data written in the data register 33 is sent to a communication control device S1 serially or in parallel via a line 3 62. At reception time, data received via the line 3 is written in the data register 33 from which the central processing storage unit CPU 10 reads it. Similarly, the central processing storage unit CPU 10 transfers data to or from an input data register 42 of the input device 1 40 and an output data register 52 of the output device 1 50. Process input data 43 sent from a controlled object 70 to the input device 1 40 is written in the input data register 42 from which the central processing storage unit CPU 10 reads it. Data written from the central processing storage unit CPU 10 to the output data register 52 in the output device 1 50 is output to the controlled object 70 as process output data 53.

The central processing storage unit CPU 10 has a line control unit 13, and the communication control device P0 30 has a line control unit 31, for controlling the transfer of data to the line 2 61. The line control units, which issue the line usage right request signal and the line usage right grant signal, and a mediation control unit 12 in the central processing storage unit CPU 10 control the mediation of those signals. The communication control device P0 30 has a line SW (bus SW) 32, the input device 1 40 has a line SW 41, and the output device 1 50 has a line SW 51. The bus SW has a switching function for electrically connecting the device to, and electrically disconnecting the device from, the line 2 61, and the switch control signal is a part of the signals sent over a line 1 60. The switching control signal, output from the mediation control unit 12 of the central processing storage unit CPU 10, establishes the one-to-one connection between the central processing storage unit CPU 10 and each of the communication control device P0 30, input device 1 40, and output device 1 50.

The central processing storage unit CPU 10 or the communication control device P0 30 can acquire the bus right in the control device for using the line 2 61. When each of the control devices acquires the bus right, the bus right usage request signal and the bus right usage grant signal of the line 1 are used to control the mediation of the line usage. When the central processing storage unit CPU 10 requests the transfer of data, the line control unit 13 outputs the line usage right request signal to the mediation control unit 12 and, after receiving the line usage right grant signal of the line 1 60 output by the mediation control unit 12, transfers the data from a data register 11 to the transfer destination via the line 2 61. On the other hand, when the communication control device P0 30 requests the transfer of data, the same procedure is used. That is, the line control unit 31 outputs the line usage right request signal to the mediation control unit 12 and, after receiving the line usage right grant signal of the line 1 60 output by the mediation control unit 12, transfers the data from the data register 33 in the communication control device P0 30 to the transfer destination via the line 2 61.

Next, the following describes a line diagnostic device 20 according to the present invention. The line diagnostic device 20 monitors the signal of the line 2 61 used for data transfer and the signal of the line 1 60 used for the mediation operation. In this embodiment, when a line usage request is issued alternately between the central processing storage unit CPU 10 and the communication control device P0 30 both of which have the bus usage right, the mediation control unit 12 mediates the use of the line 2 using the signal transmitted via line 1 60. A monitor unit 22 in the line diagnostic device 20 monitors the signal operation and the timing of the mediation operation of the line 1 in synchronization with the timing signal sent over the line 2 61. When an abnormal operation is detected on the line 2 61, the monitor unit 22 sends an abnormal condition notification to an operation instruction unit 21 in the line diagnostic device 20. Upon receiving this notification, the operation instruction unit 21 issues an instruction to the line control unit 13 in the central processing storage unit CPU 10 to stop the output of data.

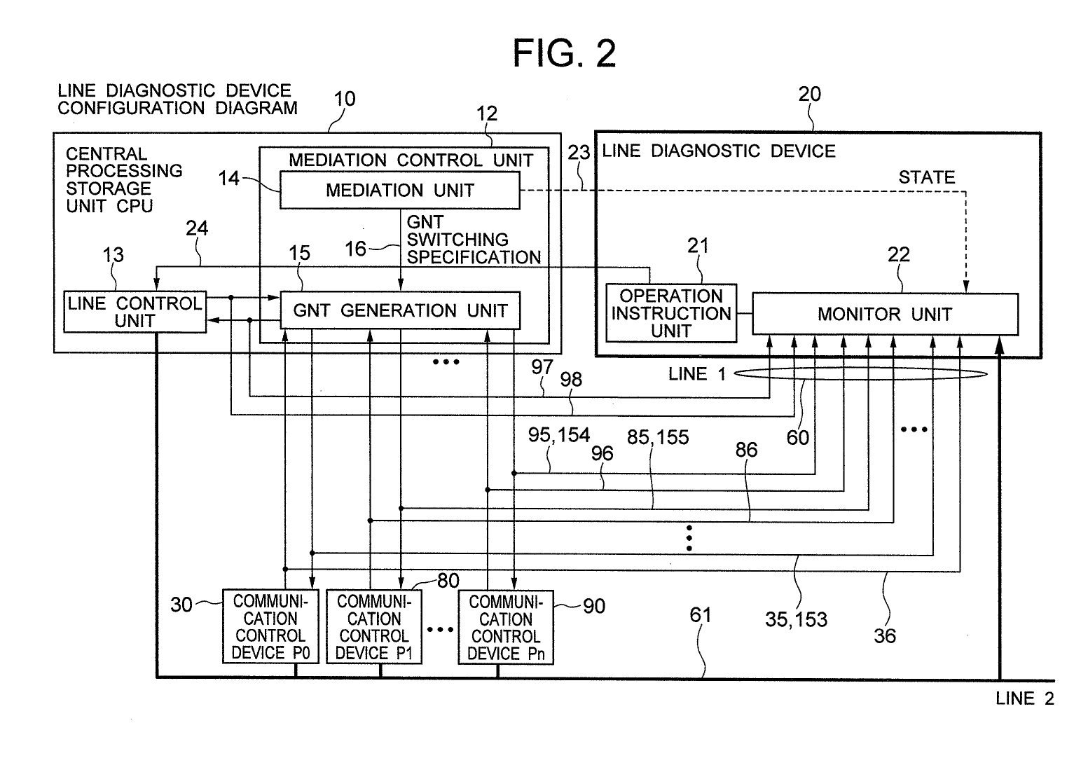

The following describes, in detail, the timing of the mediation control operation performed via the line 1 60 and the monitor operation of the line diagnostic device 20 with reference to FIG. 2.

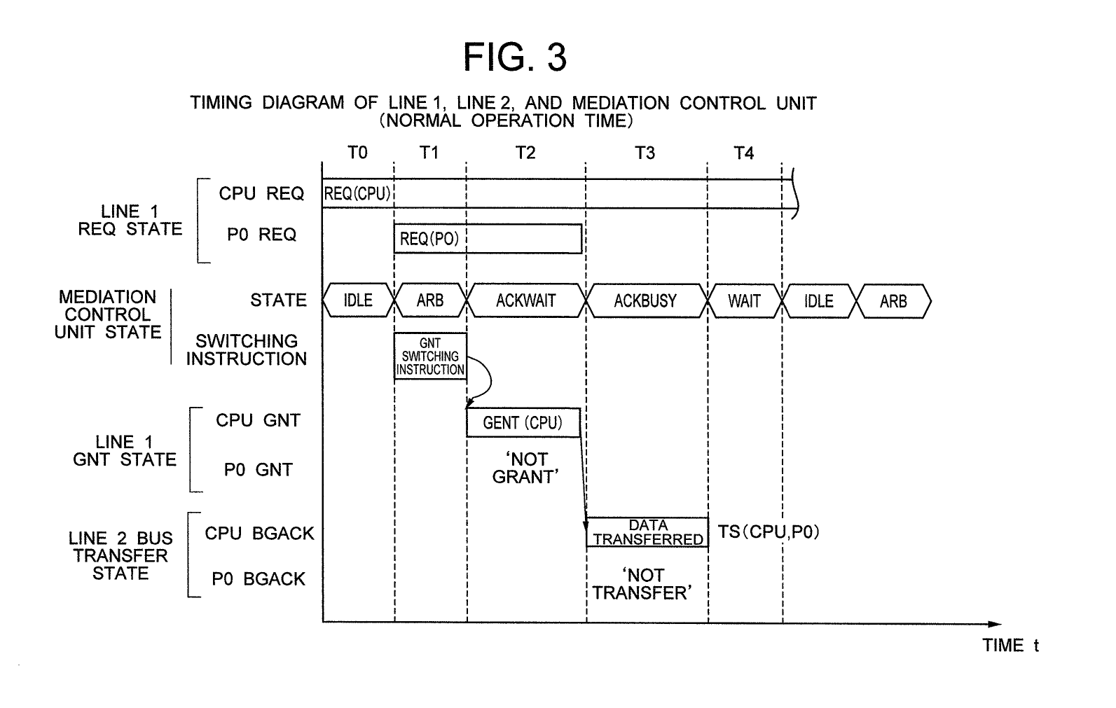

FIG. 2 shows the internal configuration of the line diagnostic device 20, the detailed timing of the mediation control operation performed via the line 1 60, and the monitor signal issued by the monitor unit 22 in the line diagnostic device 20. FIG. 2 shows a configuration comprising the central processing storage unit CPU 10 and the line diagnostic device 20 shown in FIG. 1 as well as multiple communication control devices (communication control device P0 30, communication control device P1 80, . . . , communication control device Pn 90) that output a line usage right request for the line 2 61 to make it available for use. The signals sent via the line 1 60 for controlling the mediation of the line usage right are as follows: a line usage right request signal 98 output by the line control unit 13 in the central processing storage unit CPU 10, a line usage right grant signal 97 output by a GNT generation unit 15 in the mediation control unit 12, a line usage right request signal 36 output by the communication control device P0 30, a line usage right grant signal 35 and a switch control signal 153 output by the GNT generation unit 15, a line usage right request signal 86 output by the communication control device P1 80, a line usage right grant signal 85 and a switch control signal 155 output by the GNT generation unit 15, a line usage right request signal 96 output by the communication control device Pn 90, and a line usage right grant signal 95 and a switch control signal 154 output by the GNT generation unit 15. The GNT switching specification (signal) 16, output by a mediation unit 14 in the mediation control unit 12, causes the GNT generation unit 15 to issue the line usage right grant signal to one of multiple communication control devices, from which multiple line usage requests are output, under line mediation control. The GNT switching specification (signal) 16 is generated by a state transition output from the mediation unit 14 in the mediation control unit 12, and the state transition output in the mediation unit 14 is generated based on the input/output signal state of the line 1 60 and the line 2 61. The detailed timing diagram will be shown in FIG. 3.

The line diagnostic device 20 according to the present invention, connected to the line 2 61 used as a data transfer path, is configured as a part separate from the mediation control unit 12. The line diagnostic device 20 monitors the line 1 60, the line 2 61, and a STATE signal 23 indicating the mediation operation state output by the mediation unit 14 in the mediation control unit 12 to provide means for detecting an abnormal operation in the mediation control unit. The line diagnostic device 20 has the operation instruction unit 21 that outputs an instruction to the line control unit 13 in the central processing storage unit CPU 10 when an abnormal condition is detected to provide means for stopping the output data.

In the configuration shown in FIG. 2, it is possible to monitor all signals sent via the line 1 60, on which the mediation control operation is performed between the central processing storage unit CPU 10 and the communication control devices P0 30, p1 80, and pn 90, to detect an abnormal operation of the mediation operation executed when the communication control devices issues line usage requests. This diagnostic module monitors the signals to diagnose not only the signal sticking (fixed at the high level or low level), which may occur when the signal sent via the line 1 60 is disconnected, opened, or shorted, but also a state transition malfunction in the mediation control unit 12 or an abnormal operation in a functional block. Especially, the mediation control unit, which includes complex logic usually implemented by an LSI (custom ASIC), uses a third-party part other than the LSI to diagnose not only an external signal sticking abnormality but also the internal operation of the mediation control unit when a logic abnormality in the LSI or a functional abnormality occurs. The present invention also allows the mediation operation to be diagnosed not by the software but by the hardware of the line diagnostic device 20. That is, the hardware monitor means of the line diagnostic device 20 monitors the data transfer on the line 2 61 without interrupting the software diagnostic processing, thus achieving both the safety and the responsiveness of the data transfer and the mediation control operations without affecting the data regularity and timeliness in the real-time control operation.

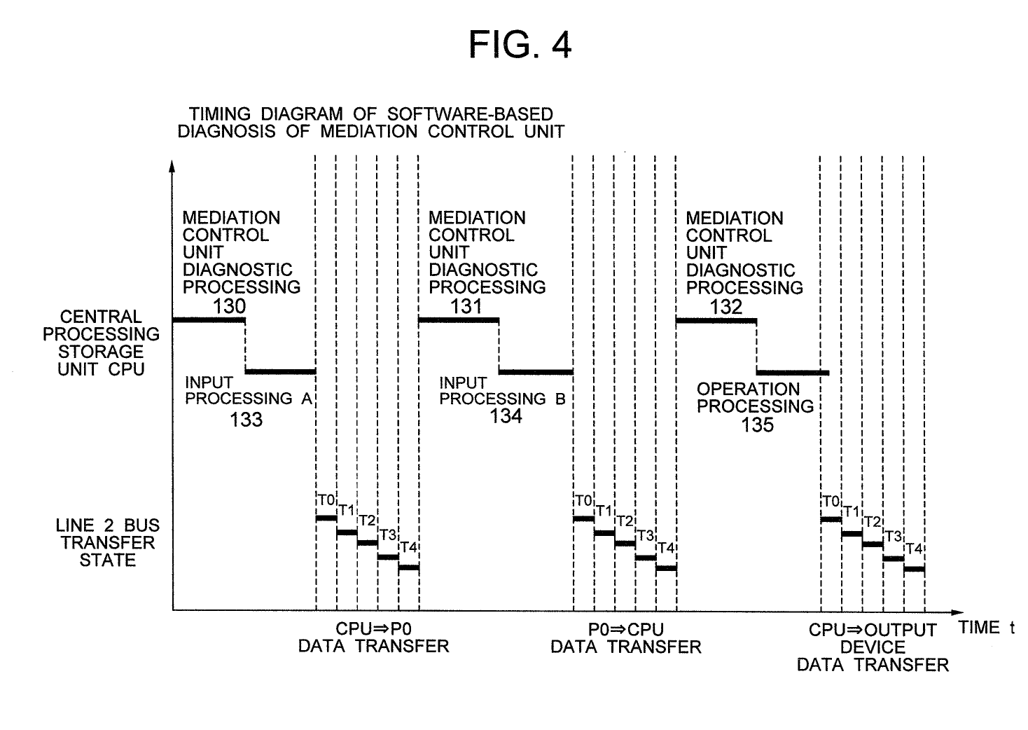

FIG. 3 is a timing diagram showing the normal operation of the mediation control unit, and FIG. 4 shows an effect on the data responsiveness and the data transfer when the mediation control unit is diagnosed via software processing.

The following describes the operation timing diagram of the mediation control unit at a normal operation time shown in FIG. 3. The timing diagram shows the state of the STATE signal 23 indicating the mediation state transition output by the mediation unit 14 in the mediation control unit 12, the state of the line usage right grant signal GNT on the line 1 60, and the bus transfer state on the line 2 61 when the central processing storage unit CPU 10 and the communication control device P0 30 issue the line usage right request of the line 2 61 in the control device composed of the central processing storage unit CPU 10 and the communication control device P0 30.

The STATE signal 23 has five states, T0-T4, from the mediation operation of the line 2 61 to the completion of bus transfer. STATE=T0, IDLE state, indicates the idle state before the bus mediation operation is started. STATE=T1, ARB state, indicates that line usage right requests are issued from multiple devices and the mediation operation is being performed. STATE=T2, ACKWAIT state, indicates a cycle in which the line usage right grant signal GNT is issued to a device, selected by the mediation operation in the ARB state, the GNT switching specification (signal) 16 is output. FIG. 3 shows an example in which GNT is issued to the central processing storage unit CPU 10. STATE=T3, ACKBUSY state, indicates that the device receiving the line usage right grant is transferring data via the line 2 61. A state transition occurs from T2 to T3 when the data transfer is started. FIG. 3 indicates that the central processing storage unit CPU 10 is transferring data. TS(CPU,P0) shown in the figure indicates that the former item in parentheses is the transfer source device and the latter is the transfer destination device. FIG. 3 shows that data is transferred from the central processing storage unit CPU 10 to the communication control device P0 30. STATE=T4, WAIT state, indicates the wait period after the data transfer is completed and before the state transition to the IDLE state occurs.

As shown in FIG. 3, the basic operation of the mediation control unit is that line usage right request signals REQ issued from multiple devices are mediated in the STATE=T1 cycle and the line usage right grant signal GNT is output to one device selected in the STATE=T2 cycle to allow the device that acquires GNT (central processing storage unit CPU 10 in FIG. 3) to transfer data via the bus. That is, in the period of the STATE=T2 cycle, GNT is not output to a device other than the central processing storage unit CPU 10 (GNT to the communication control device P0 30 in FIG. 3). Such a condition, if generated, is caused by a malfunction or a functional abnormality in the mediation control unit 12 or a signal sticking condition on the line 1 60. This condition may produces an effect that causes the communication control device P0 30 to incorrectly detect the line usage right grant signal, with a potential that the central processing storage unit CPU 10 and the communication control device P0 30 transfer data and the data correctly output by the central processing storage unit CPU 10 is destroyed.

As described above, in the timing diagram of line 2 61 to which multiple control devices output the line usage right request REQ at normal operation time, the state transition, T0-T4, repeatedly occurs under control of the mediation control unit 12 to transfer data. The line diagnostic device according to the present invention provides means that monitors the timing, the state signal, and the signals sent over the line 1 60 on a hardware basis. FIG. 4 is an operation timing diagram of the software-based diagnosis.

The following describes the flow of the software-based diagnostic operation, performed by the mediation control unit, with reference to FIG. 4. One of the advantages of the software-based diagnostic means is that the diagnosis rate of a diagnosis target can be easily increased by generating a variety of diagnostic patterns. The international safety standard IEC61508 also defines an internal diagnostic method for diagnosing signal sticking conditions and the mediation operation as the safety requirements for an arbiter, and those diagnoses can be made by the software processing. Especially, to increase the diagnosis rate of the LSI acting as the arbiter, it is recommended that the arbiter function diagnosis and the internal operation diagnosis be made.

Considering the above, the following describes the timing diagram of the software diagnosis shown in FIG. 4 while referencing the normal operation of the mediation control unit shown in FIG. 3. In the configuration shown in FIG. 1, the control device, which transfers data between the central processing storage unit CPU 10 and the communication control device P0 30, performs the diagnostic processing and the data transfer operation according to the procedure described below.

First, the central processing storage unit CPU 10 performs diagnostic processing 130 for the mediation control unit and performs input processing A 133 based on input data from a controlled object. After the input processing A 133 is completed, the central processing storage unit CPU 10 transfers data from the data register 11 to the data register 33 in the communication control device P0 30 via the line 2 61. After that, the timing diagram shows that the communication control device P0 30 acquires the line usage right grant and transfers data to the line 2 and, after that, the central processing storage unit CPU 10 acquires the line usage right grant again and transfers data to the line 2. The mediation control unit 12 performs the mediation operation to switch the line usage right grant for data transfer to allow data to be transferred based on the timing diagram of the normal operation shown in FIG. 3. The online processing performed by the microprocessor in the standard central processing storage unit CPU 10 corresponds to the input processing A 133, input processing B 134, and operation processing 135. Those types of processing are performed either in parallel with the data transfer operation on the line 2 61 or in another period to prevent the processing of the microprocessor from affecting the data transfer on the line 2 and from affecting the regularity and timeliness. On the other hand, the software-based diagnostic processing of the mediation control unit 12 corresponds to the diagnostic processing 130, diagnostic processing 131, and diagnostic processing 132, and those types of processing are performed by interrupting the data transfer on the line 2.

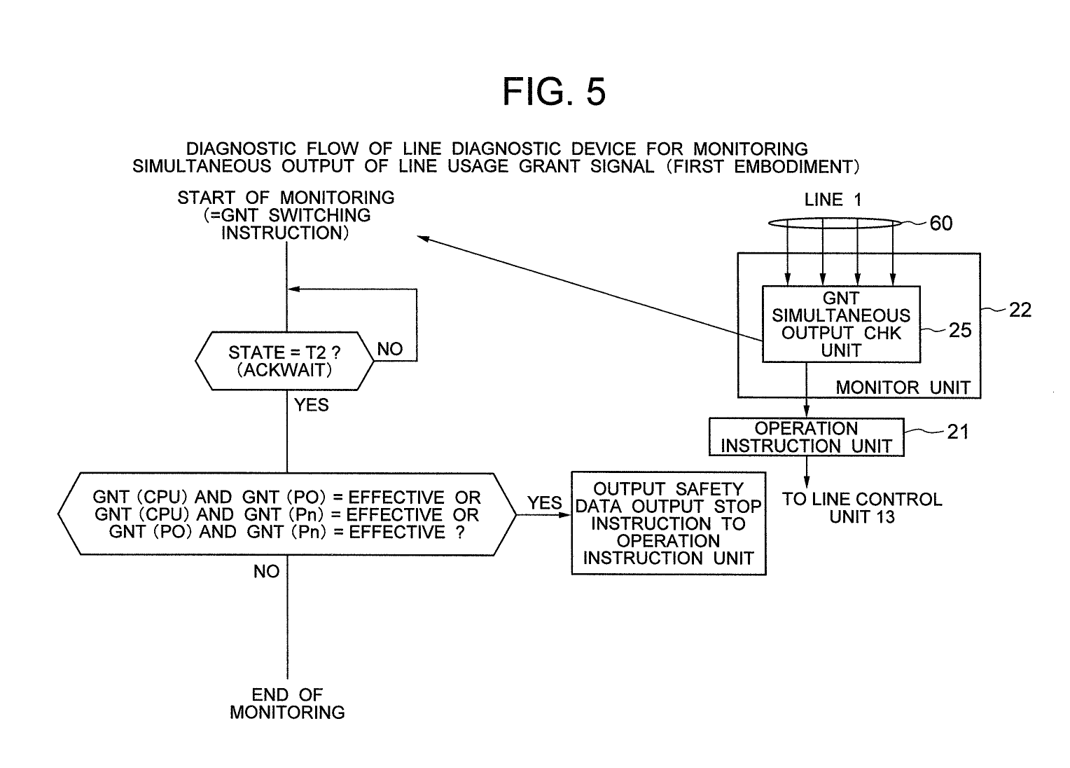

While the method described above increases the diagnosis rate though the variation in the data timeliness depends on how often the software-based diagnostic processing is performed, this method has a problem in data responsiveness, regularity, and timeliness. Therefore, the diagnostic method executed by the line diagnostic device implemented by the hardware monitor means of the present invention offers solutions to those problems. The following describes examples of the line diagnostic device of the present invention with reference to FIG. 5 to FIG. 11.

### Description of First Embodiment

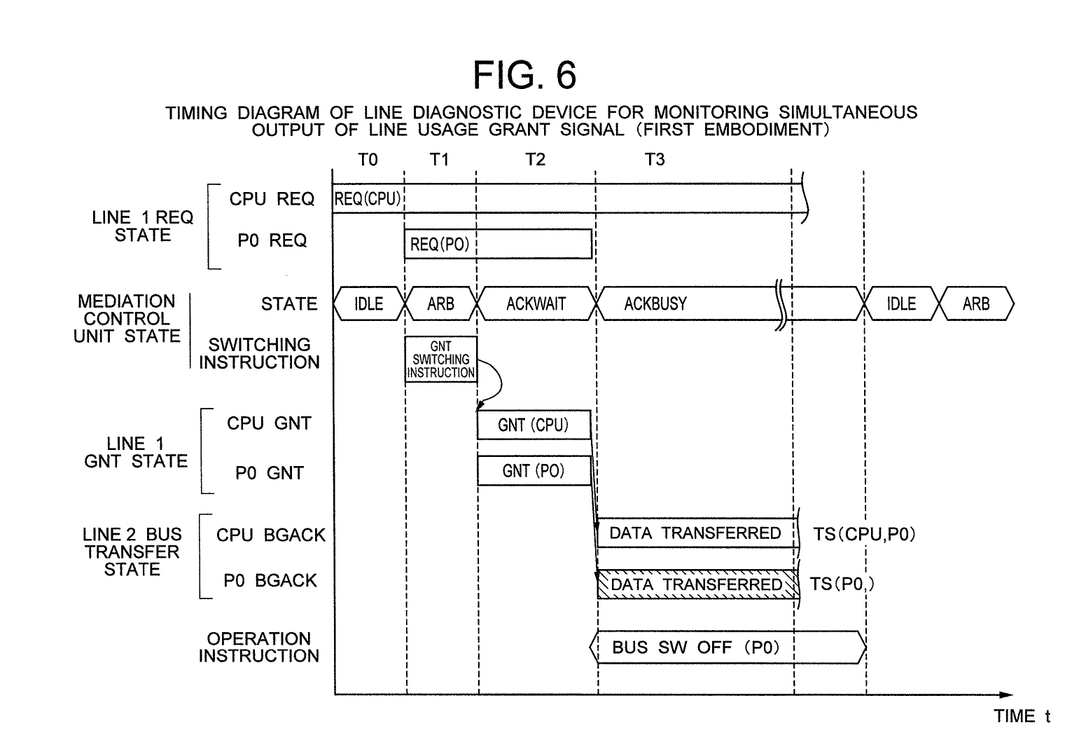

FIG. 5 and FIG. 6 show the failure mode and the abnormal operation of the mediation control unit, monitored and detected by the line diagnostic device, and one solution applied when an abnormality is detected. The description of FIG. 3 refers to the possibility of a data conflict that may occur when the line usage right grant signal GNT is issued from the mediation control unit 12 to two or more devices. The monitor unit 22 in the line diagnostic device comprises means for monitoring and detecting this failure mode. FIG. 5 shows the flow of diagnosis of the line diagnostic device 20 performed when the line usage right grant signal GNT is issued to two or more devices, and FIG. 6 is a timing diagram showing the operation performed when the GNT signal is issued to two or more devices as well as an example of a solution.

FIG. 5 shows the abnormality detection means, one of the means included in the line diagnostic device 20, for detecting an abnormality in the mediation control unit 12 and the flow of the diagnosis of the means. The monitor unit 22 in the line diagnostic device 20, which monitors the line 1 60, comprises a simultaneous output CHK unit 25 that checks if the line usage right grant signal GNT is output to two or more devices. The simultaneous output CHK unit 25 monitors if two or more line usage right grant signals GNT are issued to two or more devices. The monitor unit 22 starts monitoring when the mediation control unit 12 enters the STATE=ARB cycle. The monitor unit 22 monitors all line usage right grant signals GNT on the line 1 60 in the STATE=ACKWAIT cycle to check if the signal is issued only to one device that is effective. For example, when GNT is issued to the central processing storage unit CPU 10, the monitor unit 22 monitors if GNT is issued also to the communication control device P0 30 that is another device. The detection means checks the other combinations in the same way. If the monitor unit 22 detects a simultaneous output event (abnormality), the GNT simultaneous output CHK unit 25 issues an instruction signal to the operation instruction unit 21 in the mediation control unit 12 and, in response to this signal, the operation instruction unit 21 outputs an operation instruction signal to the line control unit 13.

FIG. 6 is an operation timing diagram of the first embodiment. As described in the operation description above, this figure shows that the line usage right grant signal GNT is issued to the central processing storage unit CPU 10 and the communication control device P0 30. (In the timing diagram, the line usage right grant signal GNT is shown as GNT(CPU) and GNT(P0)). In this condition, the central processing storage unit CPU 10 and the communication control device P0 30 transfer data and, as a result, a data conflict occurs. The line diagnostic device of the present invention detects the simultaneous output of the GNT signal in the STATE=ACKWAIT cycle and outputs the operation instruction signal to the line control unit 13 to prevent the data conflict. In response to the operation instruction signal, the line control unit 13 outputs the switch control signal=“Bus SWOFF(PO)” to the line SW 32 of the corresponding communication control device P0 to take an action for this situation.

In the first embodiment, the line diagnostic device 20 detects the simultaneous output of the line usage right grant signal GNT, generated by a failure mode such as a signal sticking condition on the line 1 60 or an abnormality in the mediation control unit 12, and takes an action for this situation to avoid a data conflict on the line 2 61 and to ensure safety.

### Description of Second Embodiment

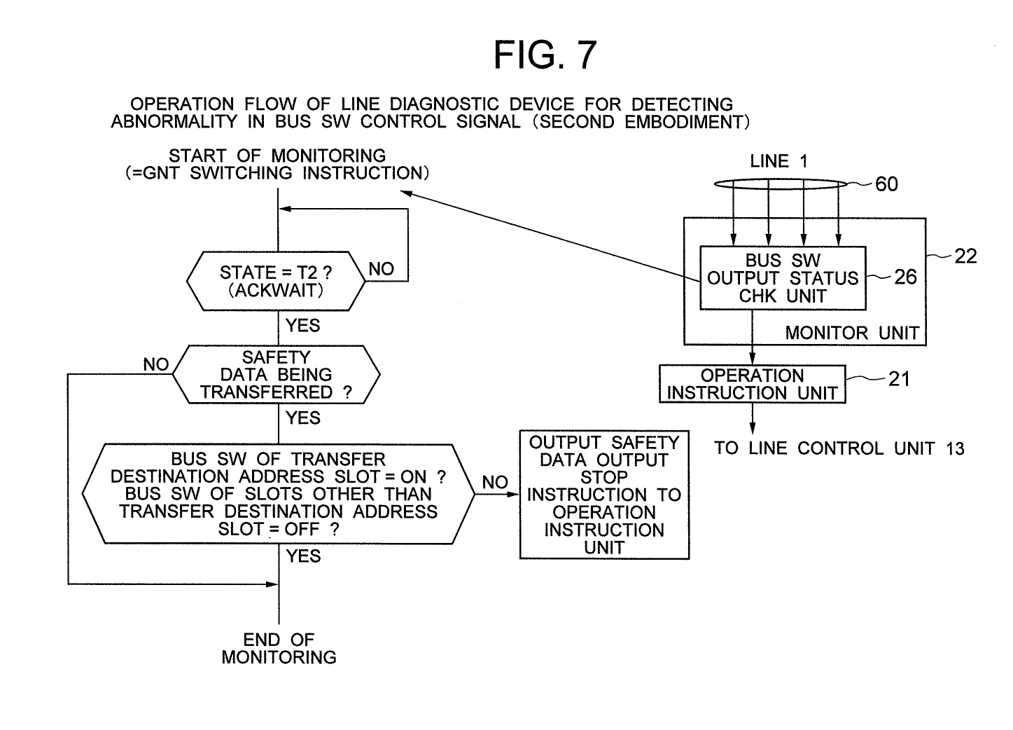

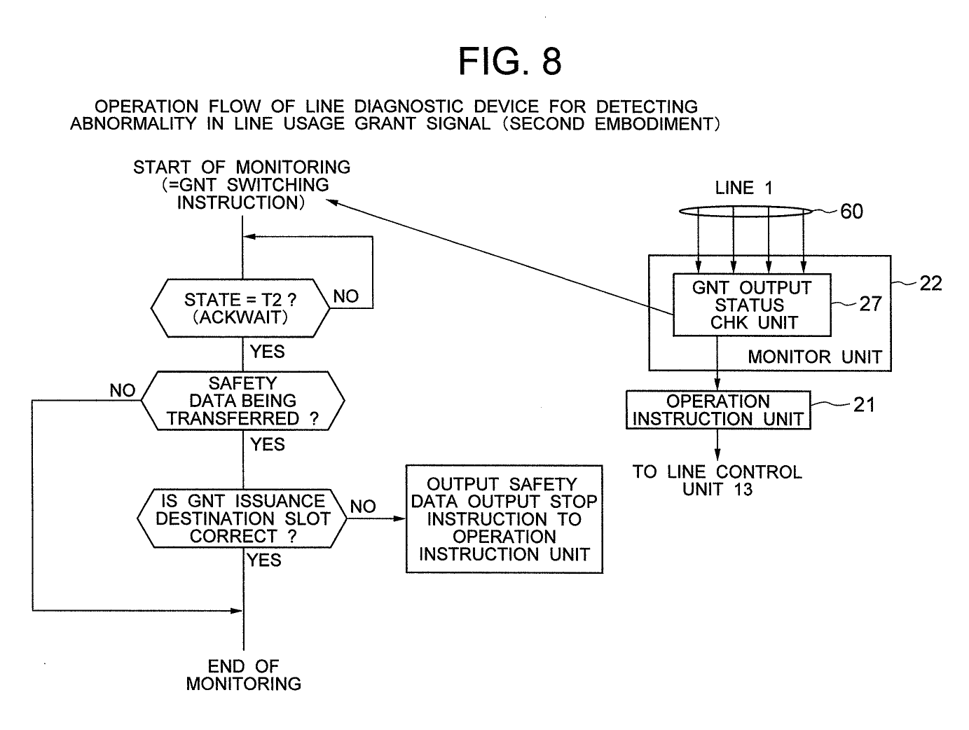

FIG. 7 and FIG. 8 show the failure mode and the abnormal operation of the mediation control unit, monitored and detected by the line diagnostic device, and another action that is taken when an abnormality is detected. FIG. 7 shows the diagnostic flow that is executed when a line diagnostic device 20 works as means for detecting an abnormality in the switch control signal. FIG. 8 shows the diagnostic flow that is executed when the line diagnostic device 20 works as means for detecting an abnormality in the line usage right grant signal GNT.

Referring to FIG. 7, a monitor unit 22 in a mediation control unit 12 has a bus SW output status CHK unit 26. The bus SW output status CHK unit 26 monitors the line 1 60 and the line 2 61. If the safety data transfer status signal, which is a part of the signals output by the central processing storage unit CPU 10 or the communication control device P0 30, indicates that “safety data is being transferred”, the bus SW output status CHK unit 26 assumes that the safety data is being transferred and compares and checks the on/off states between the transfer destination address slot and the switch control signal. The purpose of the output of the safety data transfer status signal indicating that the safety data is being transferred is to notify the whole control device that the safety data is being transferred. The data transferred to the line 2 61 is classified roughly into two: one is “safety data” that includes input/output data transferred to the controlled object 70 and protection instruction data and the other is “general data” that includes communication data used primarily for monitoring. To protect “safety data” that is transferred via the line 2 61 when the condition “safety data being transferred” is detected, the line diagnostic device of the present invention conducts diagnosis and takes an action for a potential abnormality so that the whole control device will not perform a dangerous operation when an abnormality occurs in any of the lines or in the mediation control unit.

Referring to FIG. 8, the monitor unit 22 in the mediation control unit 12 has a GNT output status CHK unit 27. The GNT output status CHK unit 27 monitors the line 1 60 and the line 2 61. If the safety data transfer status signal on the line 2 61 indicates “safety”, the GNT output status CHK unit 27 assumes that the safety data is being transferred and compares and checks the transfer destination address slot and the GNT output destination slot.

If the means shown in FIG. 7 and FIG. 8 detects an abnormality, the operation instruction unit 21 outputs the operation instruction signal to the line control unit 13. In response to the operation instruction signal, the line control unit 13 identifies that a switch control signal abnormality or a GNT signal abnormality is generated by a failure mode in the mediation control unit 12 and moves to the stop processing state of the current output data. To stop the current output data, several safety data output stop methods are possible including the freeze of the current output data or the output of the safety shutdown signal. Note that the present invention is not limited to those methods.

In the second embodiment, the line diagnostic device detects a signal sticking condition on the line 1 60 that is considered a failure mode or the incorrect output of the switch control signal or the GNT signal generated by an abnormality in the mediation control unit 12, and takes an action for those conditions to ensure safety. More specifically, when safety data is protected by the bus SW on/off control, the means shown in FIG. 7 can avoid a data conflict caused by a duplication error. For example, when the line SW of a device that may affect the safety data is disconnected under the bus SW on/off control, the means shown in FIG. 7 can avoid an abnormality that may be generated by a duplication error caused if the device whose line SW is disconnected malfunctions and if an abnormality occurs in the switch control signal issued to that device. Also, the means shown in FIG. 8 can prevent the timeout of the GNT signal output to an incorrect slot and a data conflict caused when a duplication failure occurs. Thus, as in the first embodiment, the means ensures the safety of the data transfer in the control device and the safety of the mediation control operation.

### Description of Third Embodiment

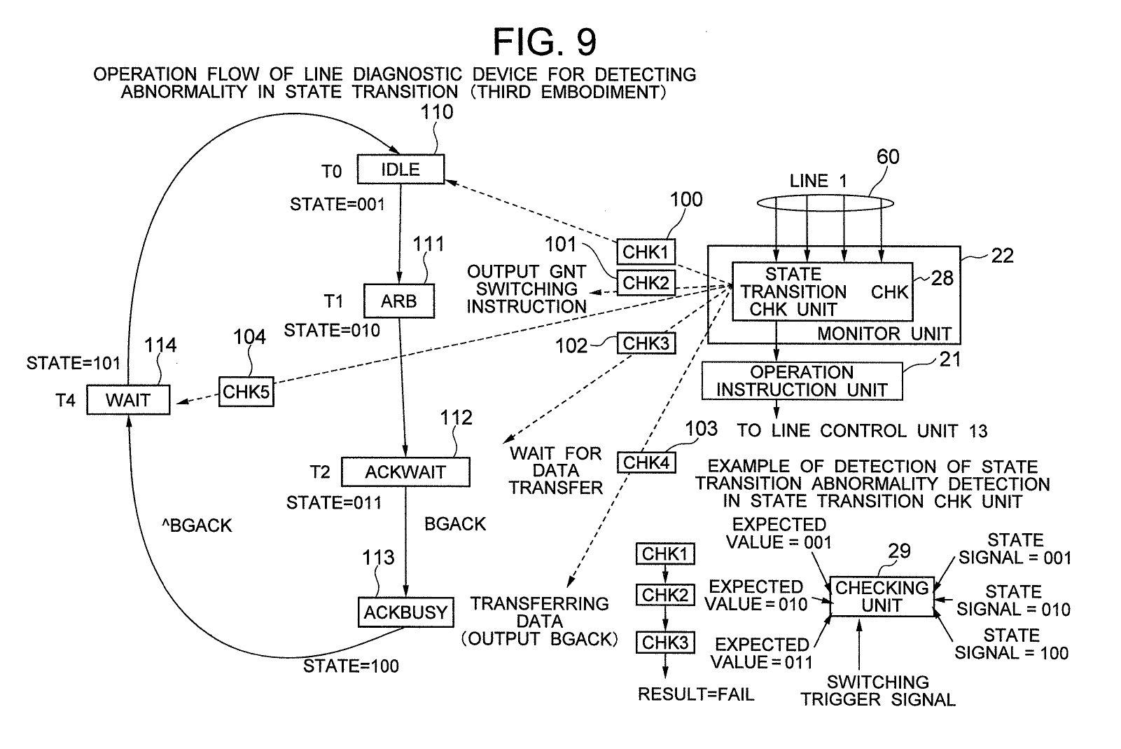

FIG. 9 shows the failure mode and the abnormal operation of the mediation control unit, monitored and detected by the line diagnostic device, and another action that is taken when an abnormality is detected. FIG. 9 shows the diagnostic flow that is executed when a line diagnostic device 20 works as abnormality detection means for detecting an abnormality in the state transition in the mediation control unit 12.

Referring to FIG. 9, the monitor unit 22 in the mediation control unit 12 has a state transition CHK unit 28. The state transition CHK unit 28 monitors a mediation state transition STATE signal 23 output by the mediation control unit 12, the line 1 60, and the line 2 61. The state transition CHK unit 28 checks the validity of the state transition sequence of the mediation state transition STATE signal 23.

The state transition during the normal operation executed by the mediation unit 14 of the mediation control unit 12 shown in FIG. 2 is as shown in FIG. 3. Usually, the state transition during the normal operation is T0(IDLE)110→T1(ARB)111→T2(ACKWAIT)112→T3(ACKBUSY)113→T4(WAIT)114, as shown in FIG. 9. In this embodiment, STATE signal 23=001 is output in the STATE=T0 cycle, STATE signal 23=010 is output in the STATE=T1 cycle and, after the subsequent cycles, the STATE signal 23 is output similarly in order of 011→100→101. The state transition CHK unit 28 monitors the state using CHK1 100, CHK2 101, CHK3 102, CHK4 103, and CHK5 104 corresponding to the STATE signals 23 output during the state transition and, if a state abnormality is detected, takes the same output data stop action that is taken in the second embodiment. CHK1-CHK5, implemented not by the software but by the hardware, starts checking when the switching trigger signal, which switches the state, is received. The state transition CHK unit 28 in the monitor unit 22 has a checking unit 29 that compares and checks the STATE signal expected value of CHK1-CHK4 and the actual STATE signal 23 output by the mediation unit 14 in FIG. 2, thus acting as means for checking using the switching trigger signal.

An example of the abnormal operation is that the state detected by CHK1 is normal (CHK1 100=STATE=001), the state detected by CHK2 is normal (CHK2 101=STATE=010), and the state detected by CHK3 is abnormal (CHK3 102=STATE=100 (expected value=011)), meaning that a state transition abnormality is detected in the ACKWAIT state detected by CHK3 102. In this case, the output timing of the GNT switching specification (signal) 16 shown in FIG. 2 is incorrect and the line usage right grant signal GNT is output to two or more device, with a possibility that a data conflict occurs on the line 2 61. When the abnormality is detected, the state transition CHK unit 28 notifies the condition to the operation instruction unit 21 as the function abnormality of the mediation control unit 12 and takes the output data stop action by means of the method shown in the second embodiment.

In the third embodiment, a state transition abnormality in the mediation unit 14 in the mediation control unit 12 that is considered a failure mode, an error in the internal logic state transition status bit, or a state transition abnormality generated by a signal sticking condition in the LSI for implementing the operation of the mediation control unit is detected, and an action is taken for them. This ensures the safety of the data transfer in the control device and the safety of the mediation control operation in the same way as in the first embodiment.

### Description of Fourth Embodiment

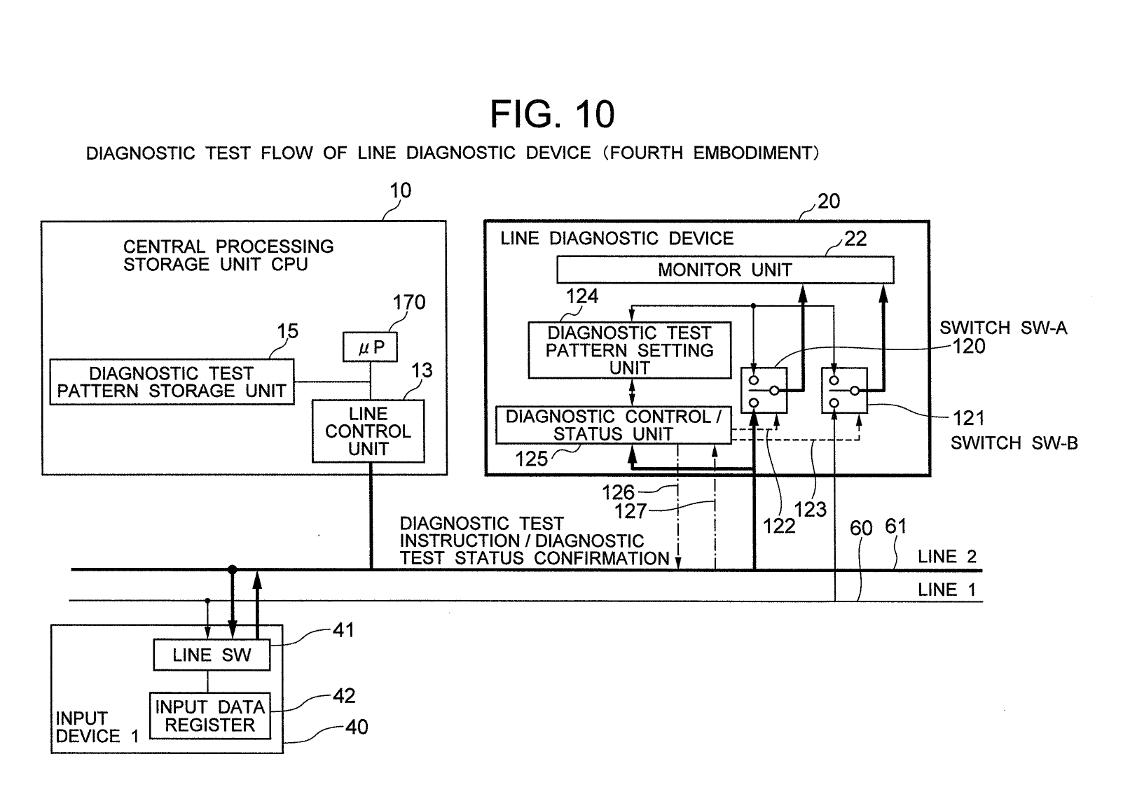

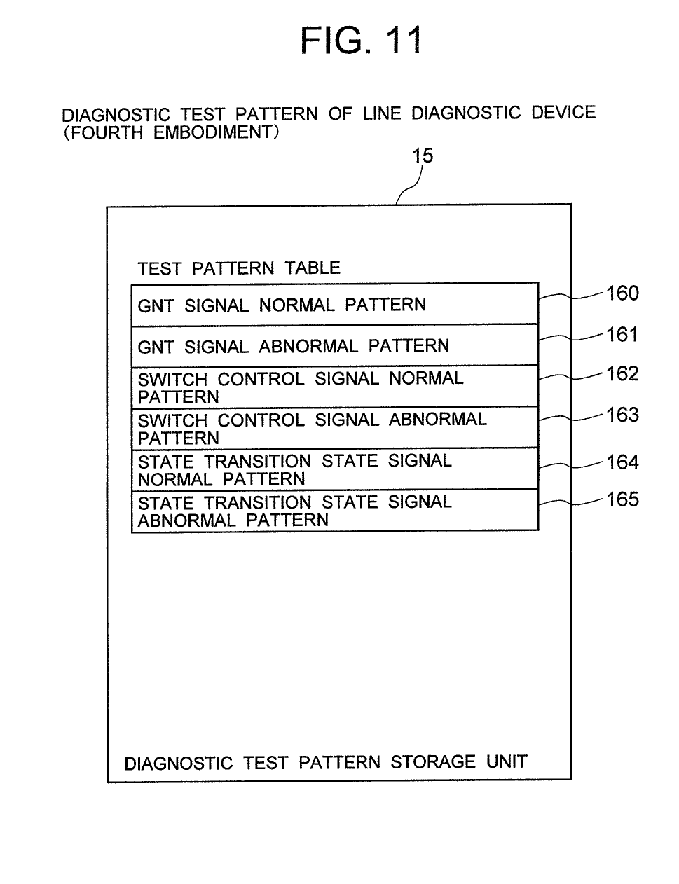

FIG. 10 and FIG. 11 show the diagnostic test means of the line diagnostic device. FIG. 10 shows the operation flow when the line diagnostic device conducts a test. FIG. 11 is an operation timing diagram.

A control device in FIG. 10 comprises a central processing storage unit CPU 10 and a line diagnostic device 20. The central processing storage unit CPU 10 comprises a microprocessor μP 170 that generates a diagnostic test pattern used by the line diagnostic device 20 for conducting a diagnostic test via software processing, a diagnostic test pattern storage unit 15 that stores a generated test pattern, and a line control unit 13 that transfers a diagnostic test pattern via a line 2 61. Next, the configuration of the line diagnostic device 20 is as follows. The line diagnostic device 20 comprises a monitor unit 22 that monitors the signals sent via a line 1 60 and the line 2 61, a diagnostic test pattern setting unit 124 that stores a diagnostic test pattern generated by the central processing storage unit CPU 10 and transferred via the line 2 61, a diagnostic control unit 125 that controls the start of a diagnostic test by a software instruction issued from a microprocessor 14 of the central processing storage unit CPU 10, and a switch SW-A 120 and a switch SW-B 121 that switch the operation between the normal monitor operation and the diagnostic test operation when the diagnostic test start instructions 122 and 123 are executed by the diagnostic control unit in response to the diagnostic test instructions 126 and 127.

The following describes the operation flow with reference to FIG. 10. The microprocessor μP 170 of the central processing storage unit CPU 10 creates a test pattern for use by the line diagnostic device 20 and writes the created diagnostic test pattern in the diagnostic test pattern storage unit 15. This diagnostic test pattern is either written once at initialization time or updated and rewritten at each execution time. Two types of diagnostic pattern are prepared and written: one is a pattern used by the line diagnostic device 20 to detect a normal operation and the other is a pattern used by the line diagnostic device 20 to detect an abnormal operation. FIG. 11 shows the detailed contents of a test pattern table. The test pattern information created by the microprocessor μP 170 is as follows. The patterns simulating the simultaneous output of the line usage right grant signal GNT described in the first embodiment, that is, a “GNT signal normal pattern” 160 that is a normal pattern and a “GNT signal abnormal pattern” 161 that is an abnormal pattern, are generated and stored. Similarly, the patterns simulating the switch control signal abnormality described in the second embodiment, that is, a “switch control signal normal pattern” 162 that is a normal pattern and a “switch control signal abnormal pattern” 163 that is an abnormal pattern, are generated and stored. Similarly, the patterns simulating the state abnormality of the state controlling STATE signal 23 described in the third embodiment, that is, a “state transition STATE signal normal pattern” 164 that is a normal pattern and a “state transition STATE signal abnormal pattern” 165 that is an abnormal pattern, are generated and stored. The microprocessor μP 170 of the central processing storage unit CPU 10 sequentially reads the test patterns and writes the test patterns, which have been read, in the diagnostic test pattern setting unit 124 in the line diagnostic device 20 via the line 2 61. When the writing of the test patterns is completed, the microprocessor μP 170 of the central processing storage unit CPU 10 issues a diagnostic test instruction 127 to the diagnostic control unit 125 in the line diagnostic device 20 via the line 2 61. In response to this diagnostic test instruction, the diagnostic control unit 125 outputs the switching instruction signals 122 and 123, respectively, to the switch SW-A 120 and the switch SW-B 121. The switch SW-A 120 is the switching switch of the line 2 61, and the switch SW-B 121 is the switching switch of the line 1 60. Both switches perform switching between data/signals, received from the line 1 and the line 2, and a data pattern read from the diagnostic test pattern setting unit, and outputs the data/signals or the data pattern to the monitor unit 22. During the normal operation, the switch SW-A 120 and the switch SW-B 121 are connected, respectively, to the line 1 60 and the line 2 61. The switching instruction signals 122 and 123, output by the diagnostic control unit 125 in response to the diagnostic test instruction 127, cause the switch SW-A 120 and the switch SW-B 121 to be connected to the diagnostic test pattern setting unit 124. After the switching operation is completed, the test pattern data stored in the diagnostic test pattern setting unit 124 is output to the monitor unit 22 via the switch SW-A 120 and the switch SW-B 121. After receiving the test pattern, the monitor unit 22 performs the test operation of the monitor unit and, if a normal pattern is received, writes the result in the diagnostic status unit 125. If an abnormal pattern is received, the monitor unit 22 writes the result also in the diagnostic status unit 125. After the writing of the diagnostic test is completed, the diagnostic test writing completion flag is set in the diagnostic status unit 125 to send a completion notification 126 to the central processing storage unit CPU 10. In response to the completion notification 126, the central processing storage unit CPU 10 reads the result information stored in the diagnostic status unit 125, and determines the result. The expected value when the normal pattern is written is “status=normal” and the expected value of the abnormal pattern is “status=abnormal”. If the result is not an expected value, it is determined that a diagnostic test error occurs. A diagnostic test error, if detected, means that the diagnostic operation performed by the line diagnostic device 20 for the mediation control does not function correctly. When the operation is being performed normally, there is no problem even if the diagnostic test is discarded. However, if a duplication error (diagnostic test error and a mediation control unit error) is generated, the abnormality in the mediation control unit cannot be detected and, in this case, the safety may be affected. This means that, when the central processing storage unit CPU 10 detects a diagnostic test error, it is necessary to stop the safety data output.

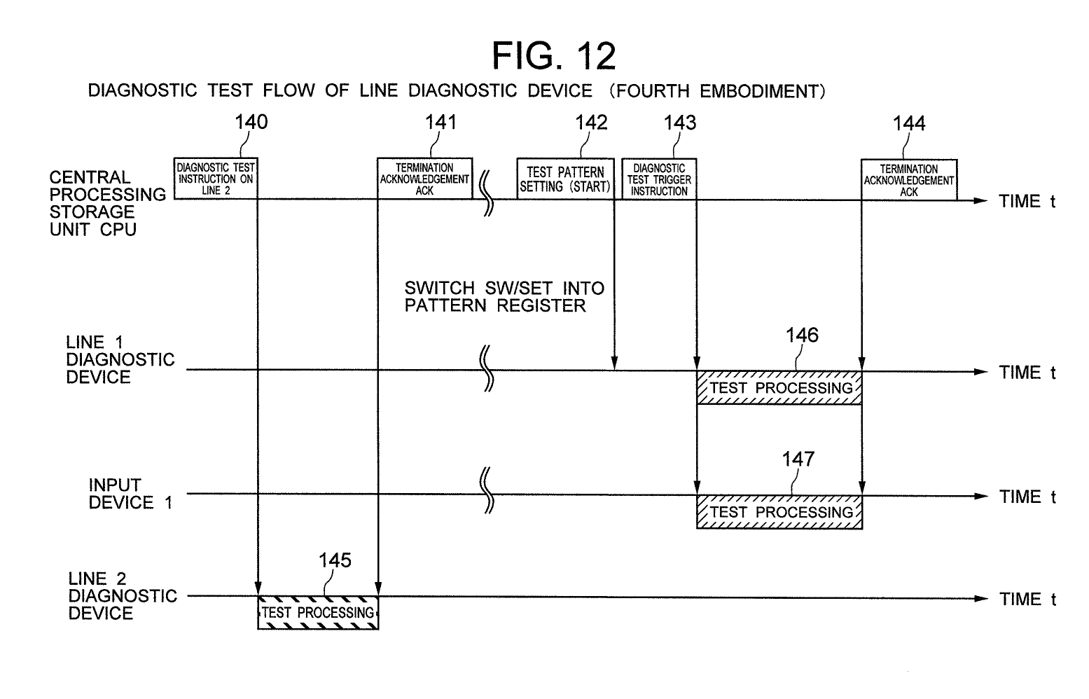

FIG. 12 is an operation timing diagram showing the diagnostic test operation performed by the line diagnostic device 20. FIG. 12 is a diagram showing the timing analysis of the diagnostic test operation among the central processing storage unit CPU 10, the line diagnostic device 20 of the present invention, another input device 1, and the line 2 61. The central processing storage unit CPU 10 first conducts the diagnostic test of the line 2 61. The central processing storage unit CPU 10 outputs a line 2 diagnostic test instruction 140 to cause a line 2 diagnostic device to perform diagnostic test processing 145 for the line 2 61. After the processing is completed, the central processing storage unit CPU 10 receives a termination acknowledgement ACK 141 to acknowledge the completion of the processing. After the line 2 diagnostic test processing is completed, the central processing storage unit CPU 10 starts the diagnostic test performed by the line diagnostic device 20 and the diagnostic test processing of other devices. As described in FIG. 10 and FIG. 11 of this embodiment, the central processing storage unit CPU 10 issues a test pattern setting 142 and issues a diagnostic test trigger instruction 143. This causes the devices to start the diagnostic test operations 146 and 147 and, finally, the central processing storage unit CPU 10 receives the termination acknowledgement ACK 144 as the termination acknowledgement and acknowledges the completion of the processing.

In the fourth embodiment, the diagnostic test conducted by the line diagnostic device 20 of the present invention is performed using test patterns generated by the microprocessor μP 170 of the central processing storage unit CPU 10 for ensuring the safety when a duplication failure occurs. The diagnostic test processing is performed by allocating a part of the software processing time to the test processing in a control cycle during the execution of online processing.

Although the devices, such as the line diagnostic device 20, are shown using the functional block diagram in the above description, the central processing storage unit and the functions described above may also be created as programs.

Embodiments of the present invention will be described below with reference to the drawings. In all of the drawings, the same reference numeral is basically given to components having the same function and repetitive description will not be given.

### Description of Fifth Embodiment

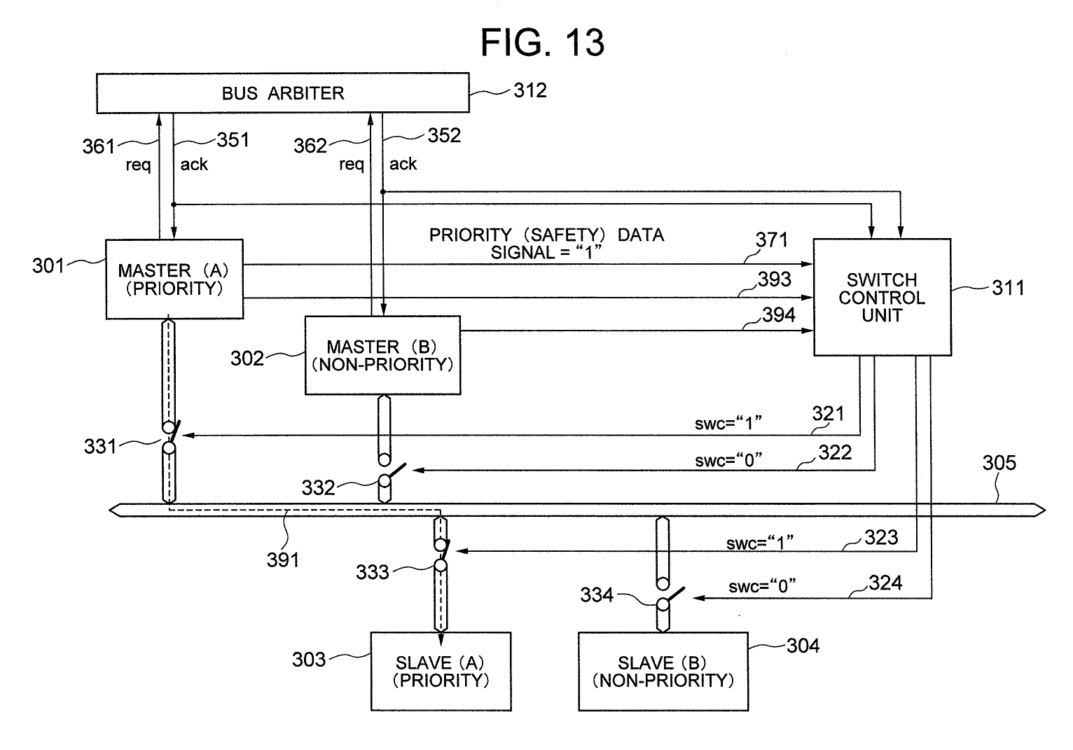

FIG. 13 is a diagram showing the configuration of a bus system in another embodiment of the present invention.

A master (A) 301, a master (B) 302, a slave (A) 303, and a slave (B) 304 are connected to a bus 305 via bus switches 331-334, respectively.

Bus switch control signal (swc) 321-324, output by a switch control unit 311, switch the bus switches 331-334 between the ON state and the OFF state. In the description below, the state is ON when the bus switch control signal (swc) is 1, and OFF when the bus switch control signal is 0.

The master (A) 301 is connected to the bus 305 when the bus switch 331 is ON, and is disconnected from the bus 305 when the bus switch 331 is OFF. The same applies to the master (B) 302, slave (A) 303, and slave (B) 304.

A bus arbiter 312 is a part that mediates requests to avoid a conflict when multiple masters request the use of the bus 305. For example, the bus arbiter receives an asserted request (req) signal 361 from the master (A) 301, and an asserted req signal 362 from the master (B) 302 and, as a result of mediation, asserts an acknowledge (ack) signal 351 or 352 of one of the masters.

The master (A) 301 or master (B) 302, whose ack signal is asserted, transfers data via the bus 305 and, after the transfer is terminated, negates the req signal and, in response to it, the ack signal is negated.

The switch control unit 311 in FIG. 13 is a part that generates the bus switch control signals (swc) for the masters and the slaves. The switch control unit 311 receives the ack signal 351 of the master (A) 301, an ack signal 352 of the master (B) 302, an address signal 393 used by the master (A) 301 for specifying a transfer destination slave, and an address signal 394 used by the master (B) 302 for specifying a transfer destination slave.

Note that there are two types of data transfer used for transferring data in the bus system of the system. The first data transfer is the transfer of data whose priority is higher than that of other (second) transfer data, for example, the transfer of data necessary to maintain the safety operation of the system. In another example, the first data is data related to the basic function of the system, and the other (second) transfer data is data related to the auxiliary function of the system.

In FIG. 13, the master (A) 301 and the slave (A) 303 are a part where the first data of the system is transferred, while the master (B) 302 and the slave (B) 304 are a part where the second data of the system is transferred. The first data in this embodiment is a target of functional safety that is transferred by priority. It is assumed that safety data is transferred only from the master (A) 301 to the slave (A) 303. The master (B) 302 and the slave (B) 304 are a part where relatively low priority ordinary data, not related to functional safety, is transferred and is not a target of functional safety.

In addition, a priority (safety) data signal 371, output by the master (A) 301, is 1 in the period of time during which the master (A) 301 transfers the first (safety) data in the bus system in FIG. 13, and is 0 in the other periods.

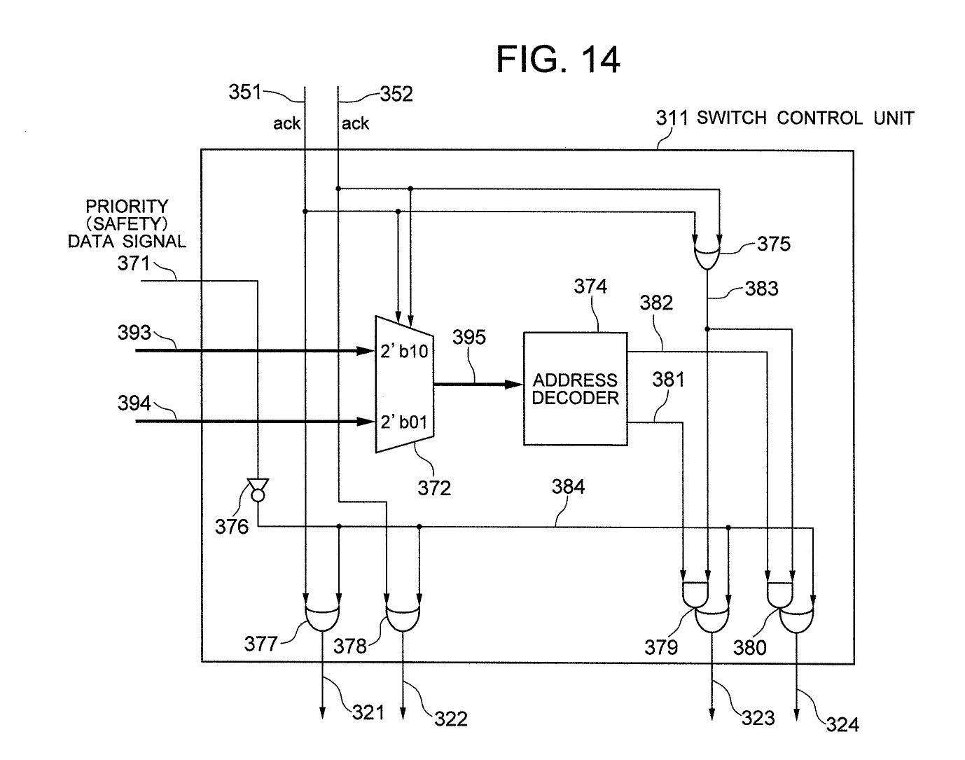

FIG. 14 is a diagram showing an example of the actual configuration of the switch control unit 311 in the fifth embodiment shown in FIG. 13 of the present invention.

In the period when the value of the priority (safety) data signal 371 is 1 and the priority (safety) data of functional safety is transferred, the value of a priority (safety) data signal 384 inverted by a NOT gate 376 becomes 0.

When the value of the ack signal 351 sent to the master (A) 301 is 1, an OR gate 377 sets the value of the bus switch control signal (swc) 321 of the master (A) 301 to 1. Similarly, when the value of the ack signal 352 sent to the master (B) 302 is 1, an OR gate 378 sets the value of the bus switch control signal (swc) 322 of the master (B) 302 to 1. When the value of the priority (safety) data signal 371 is 1, the values of the bus switch control signals (swc) 323 and 324 for the slaves are determined as follows.

The address signal 393 of the slave accessed by the master (A) 301 and the address signal 394 of the slave accessed by the master (B) 302 are output by a selector 372 as a selection address signal 395. The output of the selector 372 is selected by the ack signal 351 sent to the master (A) 301 and the ack signal 352 sent to the master (B) 302. The bus arbiter 312 mediates the ack signal 351 and the ack signal 352 so that only one of them is set to 1. The selection address signal 395 is decoded by an address decoder 374 from which slave selection signals 381 and slave selection signal 382 are output. The value of the slave selection signal 381 is 1 when the slave (A) 303 is specified as the transfer destination as a result of address decoding, and is 0 when the slave (A) 303 is not specified as the transfer destination. This applies also to the slave selection signal 382 used to specify the slave (B) 304. An ack effective signal 383, whose value is set to 1 by an OR gate 375 when one of the values of the ack signals 351 and 352 is 1, is input to AND-OR gates 379 and 380. That is, the bus switch control signal (swc) 323 sent to the slave (A) 303 causes the master to select the slave (A) 303 as the transfer destination when the priority (safety) data signal 371 is 1. Its value remains 1 only when the ack signal to one of the masters is effective and data is being transferred; otherwise, the value is 0. The value of the bus switch control signal (swc) 324 sent to the slave (B) 304 also varies in the same way the bus switch control signal (swc) 323 sent to the slave (A) 303 varies.

On the other hand, in the period when the value of the priority (safety) data signal 371 is 0 and ordinary data not related to functional safety is transferred, the value of the priority (safety) data signal 384 inverted by the NOT gate 376 is 1. Therefore, the values of the bus switch control signals (swc) 321-324, output from the OR gates 377 and 378 and the AND-OR gates 379 and 380, are all set to 1.

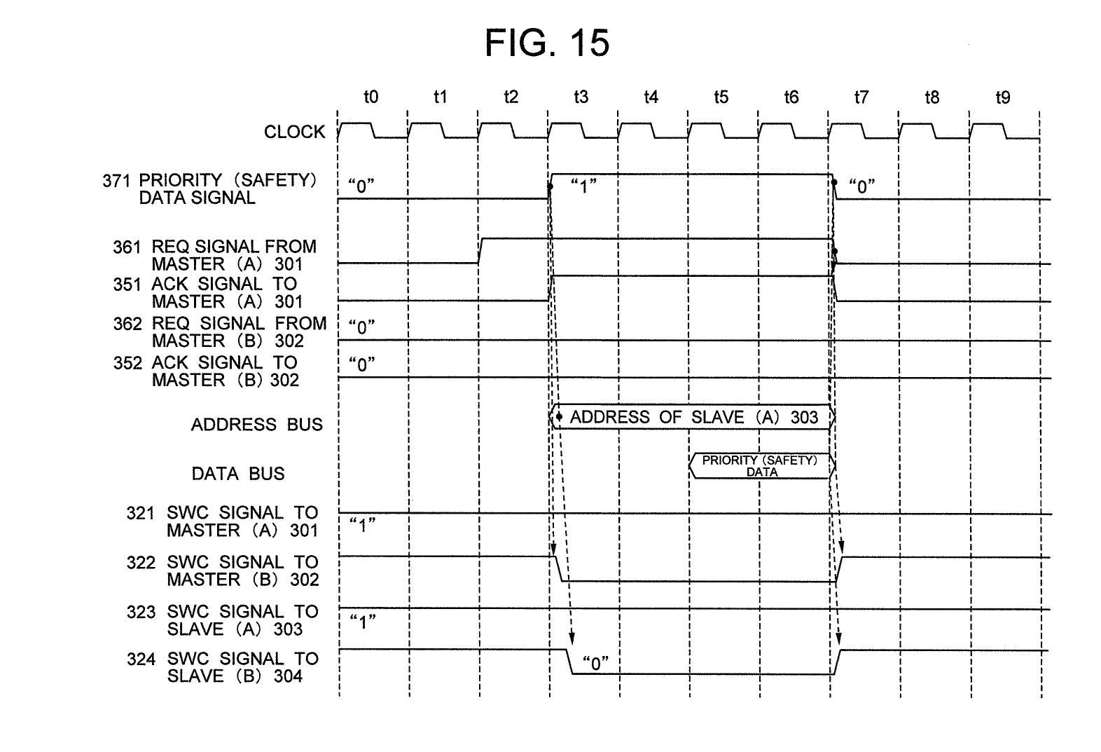

FIG. 15 is an example of the timing diagram when priority (safety) data is transferred in the embodiment of the present invention in FIG. 13 and FIG. 14. The figure is a timing diagram when the value of the priority (safety) data signal 371 is 1 and the safety data, indicated by a broken line 391 in FIG. 13, is transferred from the master (A) 301 to the slave (A) 303. In the timing diagrams in the description below, it is assumed that the value of a signal is 1 when the signal is asserted and is 0 when the signal is negated and that the address bus and the data bus in the timing diagram are lines included in the bus 305.

From clock cycle t0 to clock cycle t1 in FIG. 15, data is not transferred on the bus, the value of the priority (safety) data signal 371 is 0, and the bus switch control signals (swc) of the masters and slaves are all 1.

Assume that the master (A) 301 asserts the req signal 361 of the master (A) 301 in clock cycle t2 to request the bus for transferring priority (safety) data to the slave (A) 303. This req signal 361 remains asserted till the data transfer of the master (A) 301 is terminated.

Judging that the master (A) 301 is the only master that issues a request in clock cycle t2, the bus arbiter 312 asserts the ack signal 351 of the master (A) 301 in clock cycle t3. The master (A) 301, which has the ack signal 351 asserted, asserts the priority (safety) data signal 371 and negates the bus switch control signal (swc) 322 of the master (B) 302. In addition, the address included in the selection address signal 395 is decoded to find that the slave is the slave (A) 303, and the bus switch control signal (swc) 324 of the slave (B) 304 is negated.

The timing diagram shown in FIG. 15 indicates that the address bus includes the address of the slave (A) 303 from cycle t3 to cycle t6 and that the data bus includes safety data from cycle t5 to cycle t6.

Assume that the slave (B) 304 fails during the transfer of the priority (safety) data from clock cycle t5 to clock cycle t6 in FIG. 15 and incorrect data, which flows unintentionally into the bus 305, disturbs the data. In this case, the value of the bus switch control signal (swc) of the slave (B) 304 is 0 in the cycle from t3 to t6 and, as shown in FIG. 13, the bus switch 334, which is OFF, disconnects the slave (B) 304 from the bus 305. Therefore, the transfer of the priority (safety) data between the master (A) 301 and the slave (A) 303 via the bus 305 is not affected, and the reliability of the priority (safety) data is ensured.

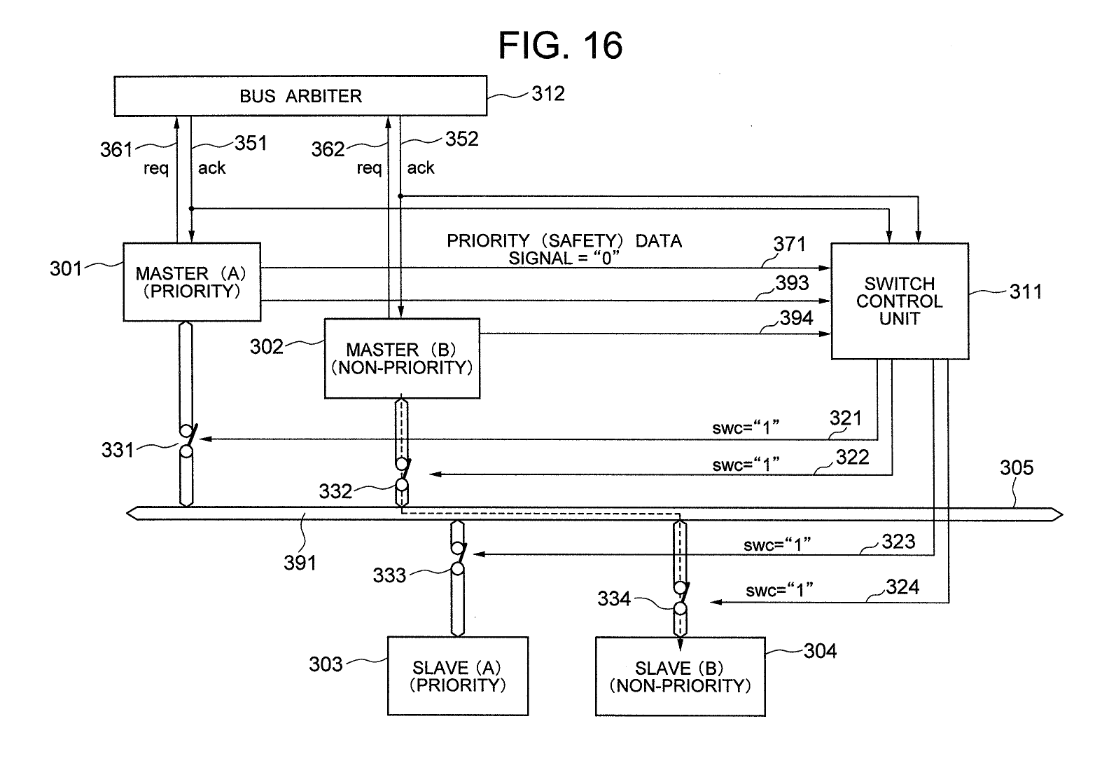

FIG. 16 is a diagram showing the states of the bus switches during the transfer of ordinary data in the bus system in the fifth embodiment of the present invention, shown in FIG. 13, when the value of the priority (safety) data signal 371 is 0.

The switch control unit 311 shown in FIG. 16 is the same switch control unit that is shown in FIG. 14. When the value of the priority (safety) data signal 371 is 0, the values of the bus switch control signals (swc) 321-324 are all 1 and the bus switch 331-334 are all ON.

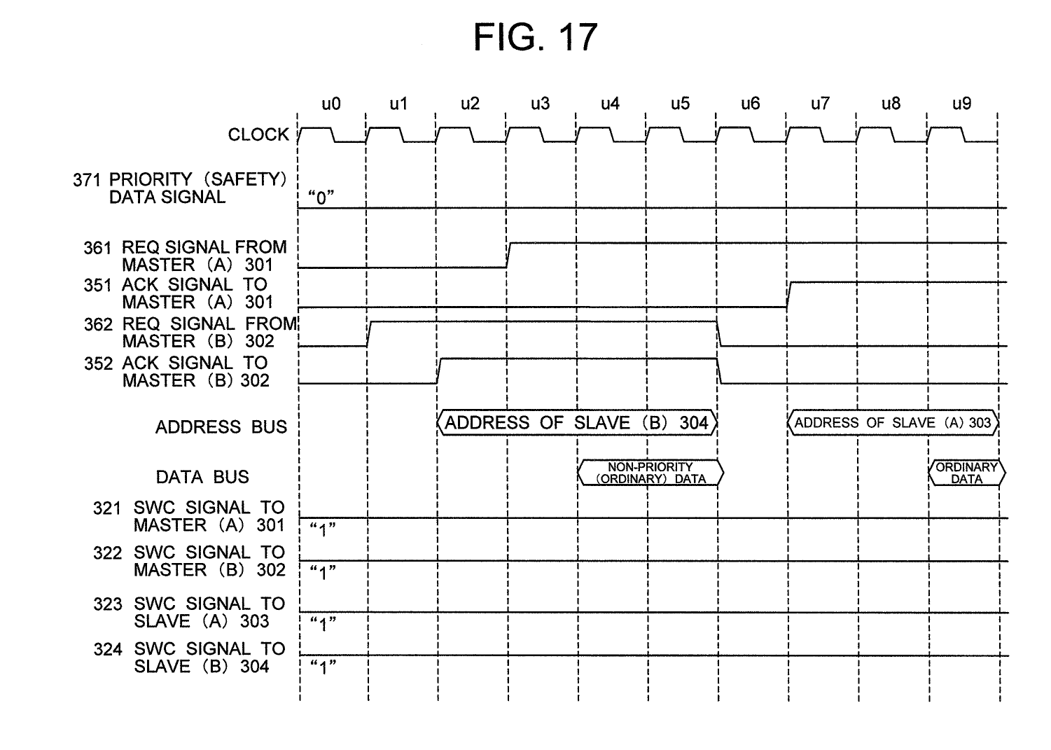

FIG. 17 is a diagram showing an example of the timing diagram of the bus system in the embodiment of the present invention shown in FIG. 16 when the value of the priority (safety) data signal 371 is 0 and ordinary data, indicated by a broken line 392 (FIG. 16), is transferred from the master (B) 302 to the slave (B) 304.

Because the value of the priority (safety) data signal 371 is 0 in the period from clock cycles u0 to u9 in FIG. 17, the values of all bus switch control signals (swc) of the masters and slaves are 1 and all bus switches are ON.

In clock cycle u1, the master (B) 302 that transfers ordinary data to the slave (B) 304 asserts the req signal 362 of the master (B) 302 to request the bus 305. Because the master (B) 302 is the only master that issues a request in clock cycle u1, the ack signal 352 of the master (B) 302 is asserted in clock cycle u2. Therefore, data is transferred from the master (B) 302 to the slave (B) 304 in the period from u2 to u5.

In clock cycle u3, the master (A) 301 that transfers ordinary data to the slave (A) 303 asserts the req signal 361 of the master (A) 301 to request the bus 305. However, because the master (B) 302 is using the bus 305, the master (A) 301 must wait until clock cycle u6 when the master (B) 302 terminates the transfer. Because the master (A) 301 is the only master that requests the bus in clock cycle u6, the master (A) 301 transfers data to the slave (A) 303 beginning in clock cycle u7.

Assume that the master (A) 301 or the slave (A) 303 fails during the transfer of data from the master (B) 302 to the slave (B) 304 in FIG. 17 and incorrect data, which flows unintentionally into the bus 305, disturbs the data. In this case, because the transferred data is not priority (safety) data but ordinary data, the functional safety is not affected and the system is not endangered.

Note that the bus system may be configured in such a way that the part corresponding to the switch control unit and the address signals are built in the master, which output safety data, to allow the switch control signal to be output from the master.

In the above embodiment, the masters and slaves, which transfer first data and second data, are mixed on the bus in the bus system where multiple masters and slaves are connected to one bus. The first data is priority (safety) data whose reliability must be guaranteed, and the second data is ordinary data other than priority (safety) data. That is, the master and the slave, which handle priority (safety) data, and the master and the slave, which does not handle priority (safety) data, are mixed on the bus. In this case, even if the master or the slave not related to the transfer of priority (safety) data fails during the transfer of the priority (safety) data on the bus, the priority (safety) data can be transferred correctly. That is, even if the failed mater or slave unintentionally flows incorrect data into the bus, the bus switch control disconnects a part not related to the transfer to allow the priority (safety) data to be transferred correctly.

In addition, when ordinary data that is not priority (safety) data is transferred, setting all bus switches to ON to make the configuration compatible with a conventional bus to allow the design of this embodiment to be added and applied to an existing bus system easily.

Although the address bus and the data bus are separate in FIG. 15 and FIG. 17, priority (safety) data can also be transferred reliably using a period during which the request signal is asserted, even if addresses and data are sent in a time-dividing manner via one shared bus.

In addition, if the salves have the direct memory access function for transferring data between the slaves, the control operation to switch the bus switches between ON and OFF also enables priority (safety) data to be transferred reliably. Ordinary data can also be transferred compatibly with a conventional bus.

Another advantage is that adding only the bus switches and the switch control unit without multiplexing the bus, masters, and salves can also implement a safe, reliable bus system.

### Description of Sixth Embodiment

Next, an example of a method for diagnosing a bus switch sticking condition in a bus system in a sixth embodiment of the present invention will be described.

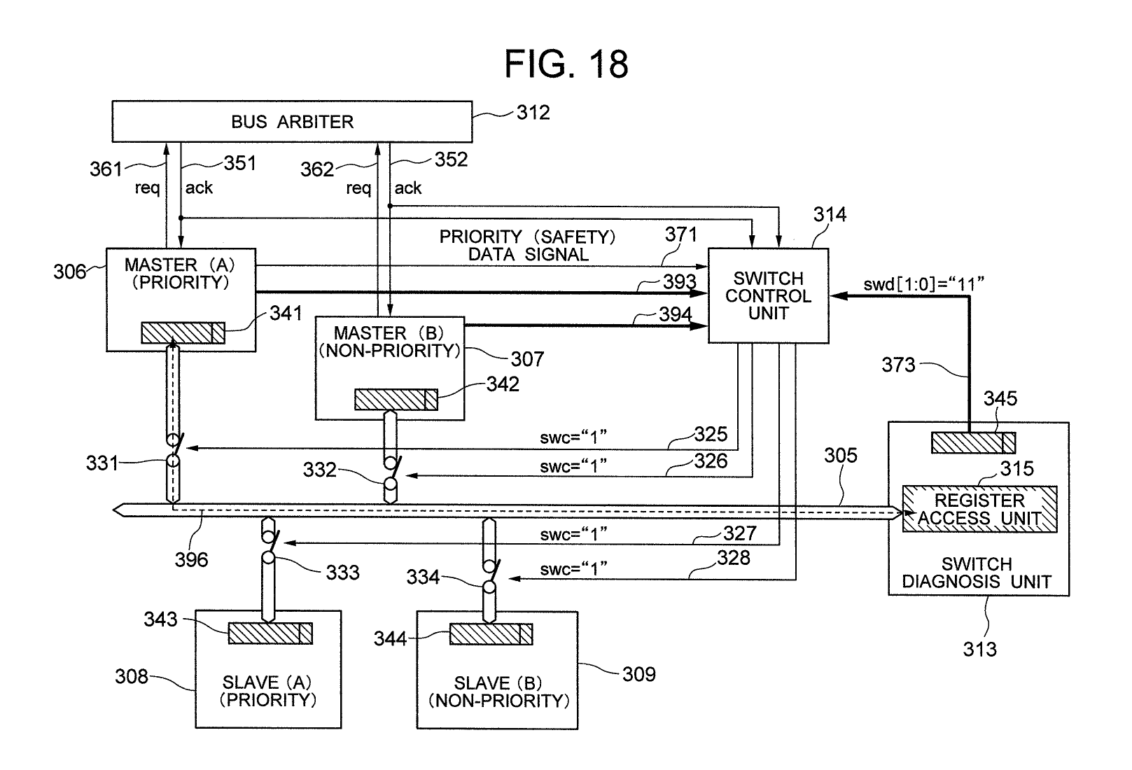

FIG. 18 is a block diagram of a bus system having the function to diagnose a bus switch OFF sticking condition in an embodiment of the present invention. This bus system is similar to that in FIG. 13 except that a switch diagnosis unit 313 and a switch diagnostic mode signal (swd) 373 are added.

A master (A) 306 contains a data register 341 that holds data, and a master (B) 307, a slave (A) 308, and a slave (B) 309 also contain data registers 342, 343, and 344, respectively. Those data registers 341-344 are interconnected via a register access unit 315 contained in the switch diagnosis unit 313 so that they can access each other via the bus 305. The register access unit 315 writes specified data to, and reads data from, the data registers 341-344.

A diagnostic mode register 345 contained in the switch diagnosis unit 313 is a two-bit register. Changing the value of the diagnostic mode register 345 changes the value of the switch diagnostic mode signal (swd) 373. The value of 1 of the low-order bit of the switch diagnostic mode signal (swd) 373 indicates the switch diagnostic processing mode in which a check is made if the bus switch is in a sticking condition, while the value of 0 indicates the normal operation mode.

In the switch diagnostic mode, the value of the high-order bit of the switch diagnostic mode signal (swd) 373 is directly output to bus switch control signals (swc) 325-328.

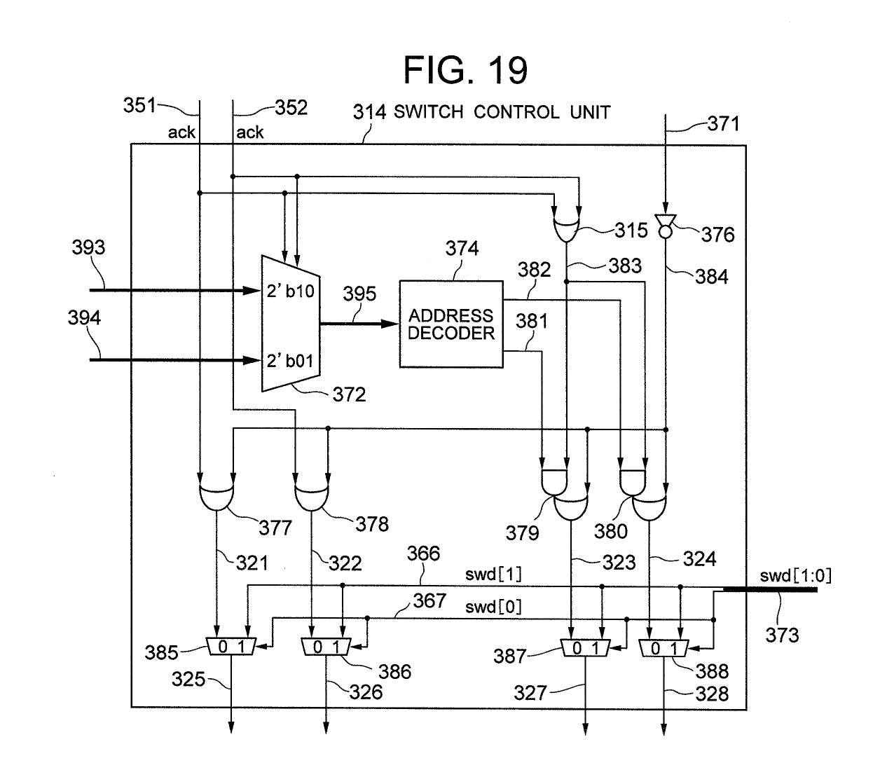

FIG. 19 is a detailed block diagram showing the switch control unit in the embodiment of the present invention shown in FIG. 18. The figure shows an example of the actual configuration of a switch control unit 314 shown in FIG. 18. This switch control unit is similar to the switch control unit 311 shown in FIG. 14 except that the switch diagnostic mode signal (swd) 373 and selectors 385-388 are added. In FIG. 19, the selector 385 receives the value of a switch diagnostic mode signal (swd) [0] 367 to select one of the bus switch control signal (swc) 321 and a switch diagnostic mode signal (swd) [1] 366, and generates the bus switch control signal (swc) 325 for the master (A) 306. This also applies to the bus switch control signals (swc) 326-328 for the master (B) 307, slave (A) 308, and slave (B) 309. When the value of the switch diagnostic mode signal (swd) [0] 367 is 1, all bus switch control signals (swc) have the same value.

The value of the two bits of the switch diagnostic mode signal (swd) 373 is 11 in FIG. 18, meaning that the switch diagnostic processing is performed. The values of the bus switch control signals (swc) 325-328 are all 1 and, as a result, the bus switches 331-334 are all ON. At this time, the register access unit 315 makes a register access 396 to the data register 341 of the master (A) 306. During the register access 396, the register access unit 315 writes diagnostic data in the data register 341 and, after writing the diagnostic data, reads the same data register 341. If the data written immediately before is read, it is determined that the bus switch 331 is correctly ON.

Conversely, if the data written immediately before is not read but different data or an arbitrary value is read, it is determined that the bus switch 331 sticks to the OFF state. Therefore, this read/write operation can avoid a situation in which data cannot be transferred due to a failure in the master (A) 306 and the system is endangered.

In this way, this embodiment can diagnose that the bus switch 331 of the master (A) 306 does not stick to the OFF state but is correctly in the ON state.

The bus switches 332-334 of the master (B) 307, slave (A) 308, and slave (B) 309 can also be diagnosed in the same way to check whether or not the switch sticks to the OFF state.

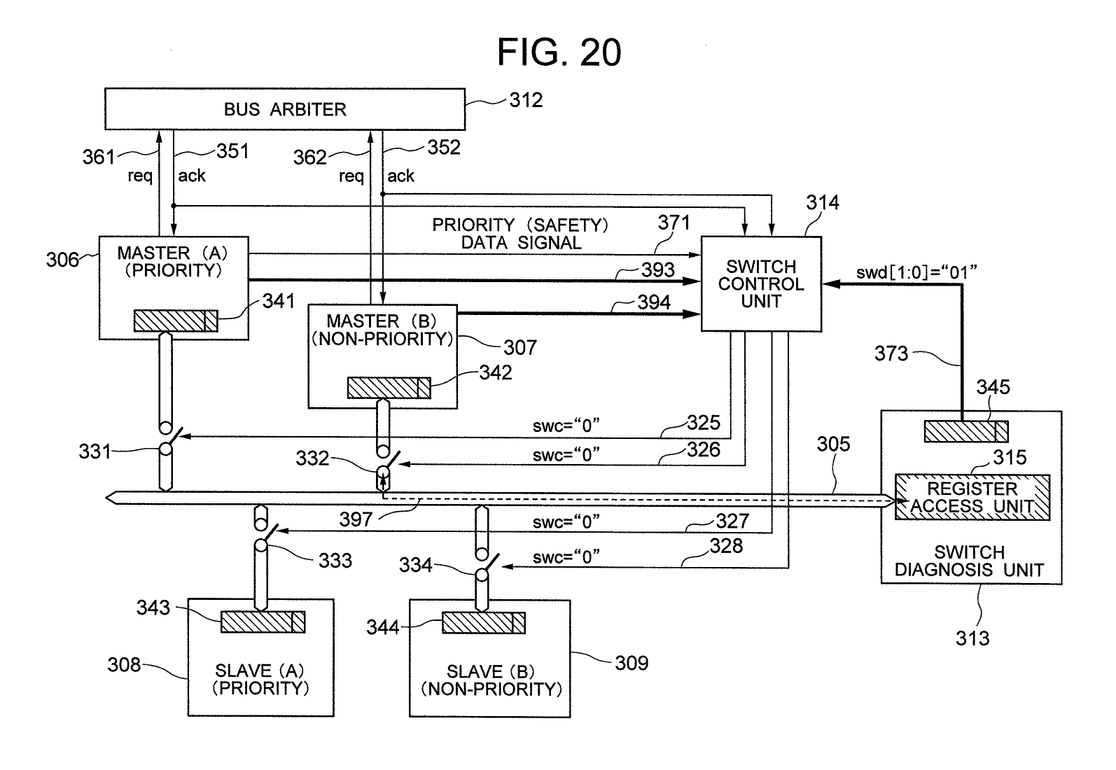

Next, FIG. 20 is a block diagram of a bus system having a mechanism to diagnose the ON sticking condition of bus switches in another embodiment of the present invention. In FIG. 20, because the value of the two bits of the switch diagnostic mode signal (swd) 373 shown in FIG. 18 is 01, the switch diagnostic processing is performed. The values of the bus switch control signals (swc) 325-328 are all 0. As a result, the bus switches 331-334 are all OFF. At this time, the register access unit 315 makes a register access 397 to the data register 342 of the master (B) 307 as indicated by the broken line. During the register access 397, the register access unit 315 writes diagnostic data and, after writing the diagnostic data, reads the same data register 342. If the data written immediately before is not read but different data or an arbitrary value is read, it is determined that the bus switch 332 is correctly OFF.

Conversely, if the data written immediately before is read, it is determined that the bus switch 332 sticks to the ON state. As a result, this read/write operation can avoid a situation in which another failure in the master (B) 307 adversely affects the bus 305.

In this way, this embodiment can diagnose that the bus switch 332 of the master (B) 307 does not stick to the ON state but is correctly in the OFF state.

The bus switches 331, 333, and 334 of the master (A) 306, slave (A) 308, and slave (B) 309 can also be diagnosed in the same way to check whether or not the switch sticks to the ON state.

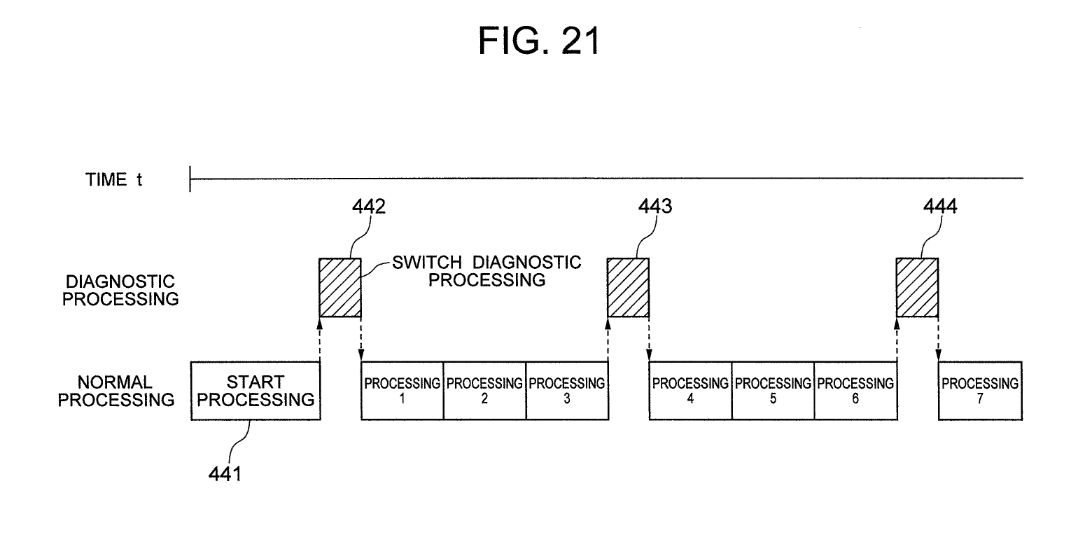

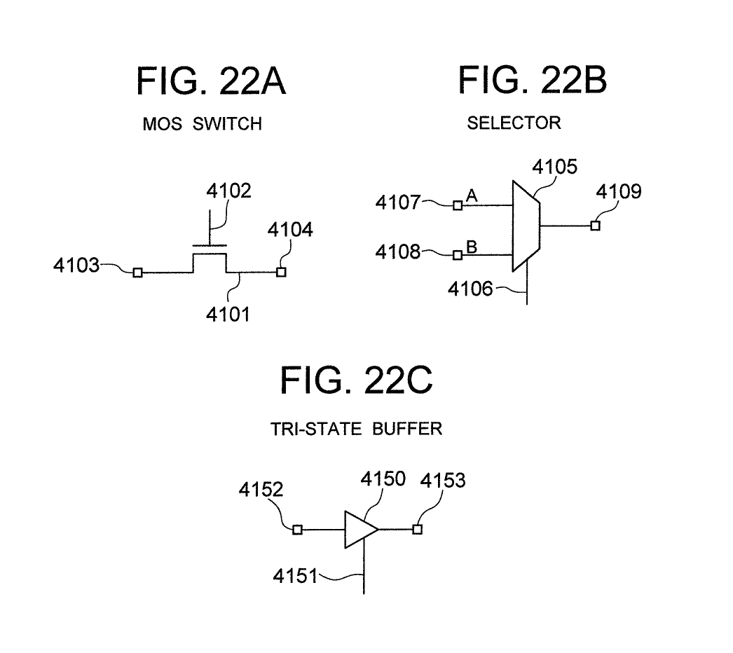

FIG. 21 is a timing diagram showing the processing flow of the bus system and the switch diagnostic processing in the embodiment of the present invention shown in FIG. 18 and FIG. 20.

After the bus system power is turned on, start processing 441 is performed first and, before normal processing is started, switch diagnostic processing 442 is performed. The switch diagnostic processing refers to the processing for checking if the bus switch sticks to the ON state and to the OFF state as described in FIG. 18 and FIG. 20. After the switch diagnostic processing 442 is terminated normally, processing 1, processing 2, and processing 3 are performed as normal processing. After that, the switch diagnostic processing is performed regularly in such a way that switch diagnostic processing 443 is performed after normal processing is performed for a fixed period of time, switch diagnostic processing 444 is performed after normal processing is performed for a fixed period of time, and so on.

If a bus switch sticking failure is detected in the switch diagnostic processing 442-444, the processing is terminated abnormally and a notification is sent to the system to avoid a dangerous situation.

According to another embodiment of the present invention described above, the diagnosis can detect a potential failure that may be caused when a bus switch sticks, increasing the reliability of the bus system and reducing the possibility that the whole system is endangered.

Although the switch diagnostic mode signal (swd) 373 is represented by the 2-bit line in this embodiment, it is also possible to provide the signal into two: the diagnostic mode switching signal and diagnostic data signal.

Although the means is disclosed in the embodiment for detecting a bus switch failure by writing to and reading from a data register, the diagnostic communication path of the communication path diagnostic device, disclosed in JP-A-2006-139634, may also be used to detect a bus switch sticking failure.

Next, the following describes the structure of a bus switch used in the bus system of the present invention.

FIGS. 22A, 22B, and 22C are diagrams showing an example of the configuration of a transistor cell used for the bus switch in the embodiment of the present invention. FIG. 22A shows an example in which an MOS switch 401 is used as the bus switch. This MOS switch 401, in which the value of a control signal 402 determines whether an input 403 is sent to an output 404, is configured by connecting the input 403 to a master or a slave and by connecting the output 404 to the bus.

In this configuration, the bus switch is implemented by controlling the value of the control signal 402 in such a way that the MOS switch is set to ON to set the bus switch to ON and that the MOS switch is set to OFF to set the bus switch to OFF.

FIG. 20B shows an example in which a selector 405 is used as the bus switch.

This selector 405, in which a control signal 406 causes one of an input (A) 407 and an input (B) 408 to be transmitted to an output 409, is configured by connecting one of the input (A) 407 and the input (B) 408 to a master or a slave and by connecting the output 409 to the bus.

The input not connected to the master is set to a high impedance state. In this configuration, the bus switch is implemented by controlling the value of the control signal 406 in such a way that the input to which the master is connected is selected to set the bus switch to ON and that the high impedance input is selected to set the bus switch to OFF.

FIG. 22C shows an example in which a tri-state buffer 450 is used as the bus switch.

In this tri-state buffer 450, the value of a control signal 451 determines whether the value of an input 452 is output to an output 453 or high impedance is output to the output 453. This tri-state buffer 450 is configured by connecting the input 452 to a master or a slave and by connecting the output 453 to the bus.

In this configuration, the bus switch is implemented by controlling the value of the control signal 451 in such a way that the value of the input 452 is output to the output 453 to set the bus switch to ON and that the high impedance is output to the output 453 to set the bus switch to OFF.

The use of a widely used general-purpose transistor cell as the bus switch as described above allows the bus switch to be implemented relatively easily and at a low cost.

The following describes examples of applications of the bus system according to the present invention.

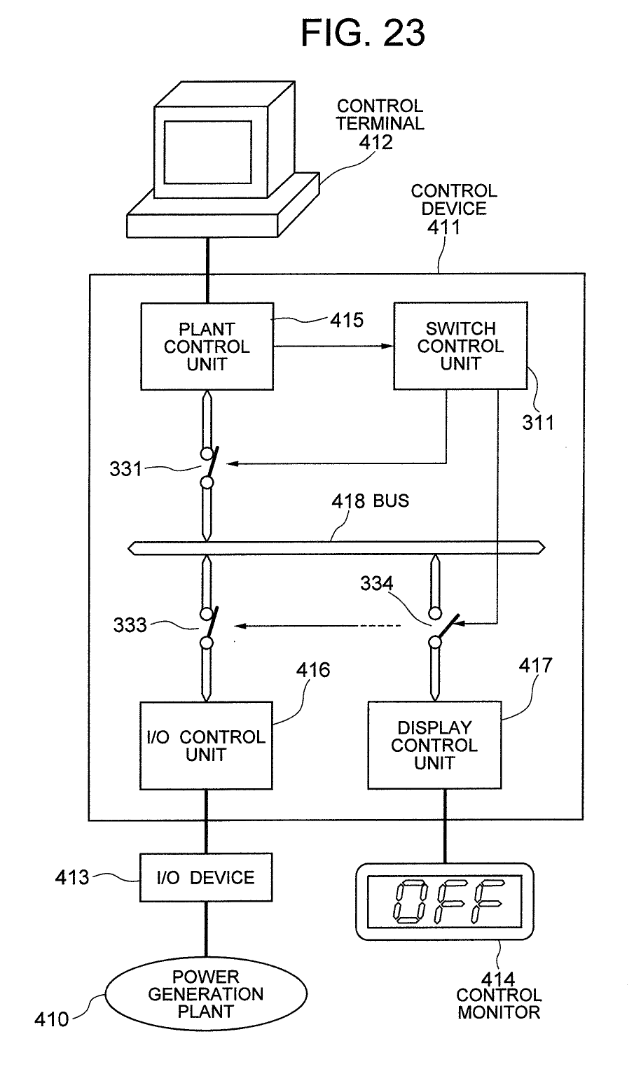

FIG. 23 is a diagram showing the block configuration in which the bus system of the present invention is applied to a power generation plant. Basically, a power generation plant 410 is controlled by a control device 411 based on a command issued from a control terminal 412. The power generation plant 410 and the control device 411 are connected by an I/O device 413, and a control monitor 414 is provided. In the control device 411, a plant control unit 415, an I/O control unit 416, and a display control unit 417 are connected via a bus 418.

Basically, the power generation plant 410 is started as follows. A command entered from the control terminal 412 causes the I/O control signal to be sent from the plant control unit 415 to the I/O control unit 416 via the bus 418. This I/O control signal starts the I/O device 413 that starts the power generation plant 410. Therefore, rather than the display control unit 417, the plant control unit 415 and the I/O control unit 416 perform the basic function to control the power generation plant 410. Therefore, the I/O control signal, which flows through the bus 418, must be highly reliable. This I/O control signal is the first data having high reliability described above.

On the other hand, the display control unit 417 monitors display data flowing through the bus 418 and displays necessary information on the control monitor 414. Therefore, this monitor-related data, which is auxiliary function data described above for the power generation plant 410, corresponds to the second data.

To apply the present invention to the power generation plant 410, the bus system is configured in which the plant control unit 415 corresponds to the master (A) 301 in FIG. 13, the I/O control unit 416 corresponds to the slave (A) 303 in FIG. 13, and the display control unit 417 corresponds to the slave (B) 304 in FIG. 13. FIG. 23 shows the switch control unit 311 and the bus switches 331, 333, and 334 corresponding to those in FIG. 13.

If the display control unit 417 fails in this application example, the display of the control monitor 414 is disturbed or erased. However, even if the display is erased, the operation of the power generation plant 410 is not affected and so the power generation should be continued. It is only required that a monitor failure can be corrected at a later time by replacing the display control unit 417 or the control monitor 414 when the plant is stopped.

To allow the control signal to be output to the power generation plant 410, the bus switches 331 and 333 are set to ON and the bus switch 334 is set to OFF as shown in the figure. Therefore, this configuration prevents the data in the bus 418 from being disturbed by a failure in the display control unit 417 and from the value of the I/O control signal from being changed unintentionally. This means that this configuration ensures the correct I/O control operation, avoids the worst situation in which the power generation plant cannot be controlled, and increases the reliability of the power plant system.

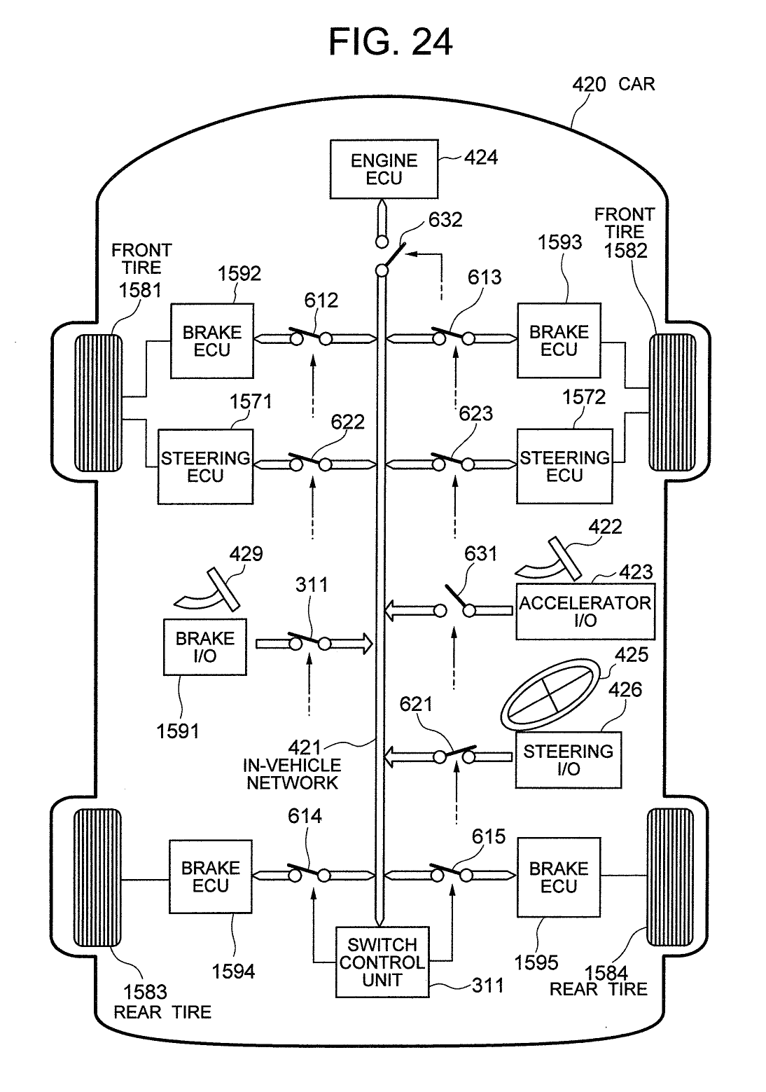

FIG. 24 is a diagram showing the block configuration in which the bus system of the present invention is applied to a car system. Various ECUs (Electric Control Unit) for controlling the driving of a car 420 are connected to the car 420 via an in-vehicle network 421. First, the acceleration signal, which varies according to the pressing amount of an accelerator pedal 22, is transmitted from an accelerator I/O device 423 to an engine ECU 424 to change the number of engine rotations for changing the speed of the car 420. The steering signal, which varies according to the operation of a steering wheel 425, is transmitted from a steering I/O device 426 to steering ECUs 1571 and 1572 to change the direction of front tires 1581 and 1582 for changing the driving direction of the car 420. In addition, a brake signal, which varies according to the pressing amount of a brake pedal 429, is transmitted from a brake I/O device 1591 to brake ECUs 1592-1595 to decelerate or stop the car 420.

Note that, for the car 420, a command for the steering wheel and the brake is more important than a command for the engine. That is, a command for the engine corresponds to the second (ordinary) data of the present invention, and a command for the steering wheel and the brake corresponds to the first data transfer necessary for maintaining the safety operation of the system.

During the period when the brake pedal 429 is pressed and the brake command is active, the switch control unit 311 controls the bus switches so that the fuel injection command from the accelerator pedal 422 is inhibited. That is, bus switches 611-615 for the brake and the bus switches 621-623 for the steering wheel are always ON, and bus switches 631-632 for the accelerator are set to OFF during the period when the brake pedal 429 is pressed and the brake command is active.

Even if the value of the acceleration signal (fuel injection command) is garbled and the speed changes unintentionally when the engine ECU 424 fails, the driver can press the brake pedal 429 to stop the car correctly for maintaining the safety of the car system.

Even if the engine ECU 424 fails and incorrect data flowing through the in-vehicle network 421 disturbs the operation, the driver can press the brake pedal 429 to disconnect the engine ECU 424 from the in-vehicle network 421 by means of the corresponding bus switch 432 as shown in the figure. This configuration avoids a brake failure due to a garbled brake signal and an improper steering due to a garbled steering signal, and ensures the safety of the car system.

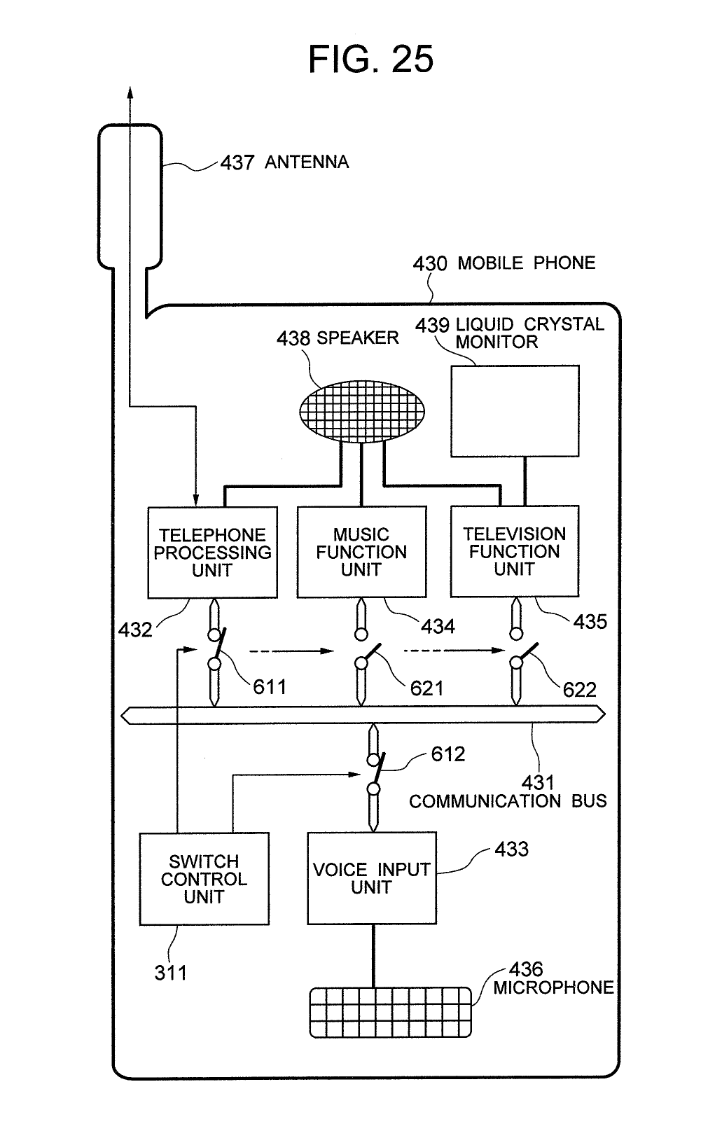

FIG. 25 is a diagram showing the block configuration in which the bus system of the present invention is applied to a multi-function mobile phone. The multi-function mobile phone refers to a mobile phone having the music function and the television function. In this case, the multi-function mobile phone is fundamentally a mobile phone, the bus system is configured with priority given to the telephone function judging that the telephone function is considered more important than the music function and the television function.

The internal configuration of a mobile phone 430 is that a telephone processing unit 432, a voice input unit 433, a music function unit 434, and a television function unit 435 are connected via a communication bus 431.

When the mobile phone 430 is used as a telephone that is the basic function, the telephone processing unit 432 and the voice input unit 433 start the operation. In this case, the switch control unit 311 sets the bus switches 611 and 612 to ON, and sets the other bus switches 621 and 622 to OFF. In this state, voices entered from a microphone 436 are converted to radio waves and are transmitted to a telephone at the other end of the line via an antenna 437 and a base station. Radio waves from the telephone at the other end of the line, sent from a base station, are received and converted to voices and are output to the user via a speaker 438.

When other auxiliary functions of the mobile phone are used, the switch control unit 311 sets all bus switches 611, 612, 621, and 622 to ON.

First, when the music function is used, the music function unit 434 starts the operation and reproduces favorite music from the music data stored in the mobile phone via the bus switch 621 and the communication bus 431, and outputs the reproduced music from the headphone speaker 438. Next, when the television function is used, the television function unit 435 starts the operation, converts the radio waves received from the bus switch 622 via the communication bus 431 into videos and sounds, and outputs them to a liquid crystal monitor 439 and the (headphone) speaker 438.

Even if the music function unit 434 or the television function unit 435 fails, the configuration described above minimizes the failure to such a degree that the sound or the display is disturbed or the sound is not heard.

However, if a failure in the music function unit 434 or the television function unit 435 causes incorrect data to flow into the communication bus 431, there is a possibility that the failure affects the telephone function that is the core function, prevents a correct telephone call from being made, and disables the telephone function itself. To avoid this situation, the bus switches 611 and 612 related to the communication are set to ON and the bus switches 621 and 622 related to the music function unit 434 and the television function unit 435 are set to OFF during a telephone call, as shown in the figure, to prevent the telephone function from being disturbed.

The bus system of the present invention is applicable not only to the power generation plant, the car, or the multi-function mobile phone such as those shown in FIGS. 23-25, but also to a wide range of fields such as control devices or semiconductor integrated circuits used in industrial systems or railway vehicles for increasing the reliability of those systems.

It should be further understood by those skilled in the art that although the foregoing description has been made on embodiments of the invention, the invention is not limited thereto and various changes and modifications may be made without departing from the spirit of the invention and the scope of the appended claims.

1. A line diagnostic device comprising:
a mediation control unit that sends and receives a usage right mediation signal of a second communication line via a first communication line wherein information on a controlled object is sent and received via said second communication line; and
a diagnosis unit that monitors signals on said first communication line for checking for an abnormality in said mediation unit wherein
if an abnormality is found in said mediation unit, said diagnosis unit outputs a signal for suppressing a communication on said second communication line.

2. The line diagnostic device according to claim 1 wherein said first communication line includes, at least in part, parallel transmission and said second communication line includes, at least in part, serial transmission.

3. The line diagnostic device according to claim 1 wherein the checking for an abnormality is made by performing monitoring of a communication operation on said first communication line and monitoring of a communication operation on said second communication line.

4. The line diagnostic device according to claim 1 wherein, if communication on said second communication line is granted for two or more communication control devices, said line diagnostic device determines that said mediation unit is abnormal.

5. The line diagnostic device according to claim 4 wherein the information on the controlled object is sent to and received from a central processing storage unit via said second communication line and, if the abnormality is found, an instruction is issued from said central processing storage unit to stop an operation on the communication.

6. The line diagnostic device according to claim 1 wherein the information on the controlled object is sent to and received from a central processing storage unit via said second communication line and said diagnosis unit is configured as a piece of hardware separate from said central processing storage unit.

7. A line diagnostic device for use in a control device in which data is transferred to and from a connection device which transfers information between a central processing storage unit and a controlled object via a second communication line, and to and from a communication control device via the second communication line, said communication control device sending data to, and receiving data from, a controlled object via a third communication line to which one or more communication control devices are connected serially at least in part, said control device comprising a mediation control unit that mediates a usage right of the second communication line; a first communication line for communicating a line usage request and a line usage right grant signal; and said line diagnostic device connected to the first communication line, said line diagnostic device comprising a detection unit that monitors the first communication line and the second communication line for detecting an abnormal operation of signals related to said mediation control unit and the first communication line in case that; and an instruction unit that, after an abnormality is detected, issues an instruction to stop a communication of the second communication line via the second communication line.

8. The line diagnostic device according to claim 7 wherein each of the devices connected to the second communication line has a bus switch that connects or disconnects a path to the second communication line via the first communication line, said mediation control unit outputs a signal for connecting to or disconnecting from the bus switch, said line diagnostic device monitors the first communication line, and said mediation control unit issues a command to connect to or disconnect from the second communication line in case that, said line diagnostic device further comprising:
a detection unit that detects an abnormal operation of the output signal; and
a stop instruction unit that, after detecting an abnormality, stops a data output by outputting an operation instruction to a second communication line control unit.

9. The line diagnostic device according to claim 7, further comprising;
a detection unit that monitors a simultaneous output of a usage grant signal on the first communication line, which is output to the devices, including said central processing storage unit and the communication control device, to which a usage of the second communication line s granted, for detecting an abnormal operation, caused by the simultaneous output of the usage grant signal during a data transfer mediation during a safety operation with a data transfer interruption suppressed while, monitoring a safety operation signal indicating that safety data that is output by a line control unit is being transferred; and
a stop instruction unit that, after detecting an abnormality, stops a data output by outputting an operation instruction to a second communication line control unit.

10. The line diagnostic device according to claim 7, further comprising:
a detection unit that monitors an output signal, which is a connection or disconnection command for a bus switch sent via the first communication line that is output to the central processing storage unit, the communication control device to which a use of the second communication line is granted, and an input device and an output device that controls the controlled object via the second communication line, and transfer destination address information sent via the second communication line for detecting an abnormal operation detected in case that a mismatch is detected between the output signal, which is the connection or disconnection command for the bus switch, and the transfer destination address information during a data transfer mediation during a safety operation with a data transfer interruption suppressed while, monitoring a safety operation signal indicating that safety data that is output by a line control unit is being transferred; and
a stop instruction unit that, after detecting an abnormality, stops a data output by outputting an operation instruction to a second communication line control unit.

11. The line diagnostic device according to claim 7, further comprising:
a detection unit that monitors a usage grant signal sent via the first communication line, which is output to the central processing storage unit and each device to which a grant of the second communication line is sent, and transfer destination address information sent via the second communication line for detecting an abnormal operation caused in case that a mismatch is detected between the usage grant signal and the transfer destination address information during a data transfer mediation during a safety operation without interrupting a data transfer while, monitoring a safety operation signal indicating that safety data that is output by a line control unit is being transferred; and
a stop instruction unit that, after detecting an abnormality, stops a data output by outputting an operation instruction to a second communication line control unit.

12. The line diagnostic device according to claim 7, further comprising:
a detection unit that monitors a state signal output by said mediation control unit (for detecting a state transition abnormality of the state signal during a data transfer mediation during a safety operation without interrupting a data transfer while, monitoring a safety operation signal indicating that safety data that is output by a line control unit is being transferred; and
a stop instruction unit that, after detecting an abnormality, stops a data output by outputting an operation instruction to a second communication line control unit.

13. The line diagnostic device according to claim 7, further comprising:
a test execution unit that writes test patterns into said line diagnostic device via the second communication line and switches control to a test circuit based on a diagnostic test command from a microprocessor μP for conducting a test of a monitor unit of said line diagnostic device wherein the test patterns, generated by the microprocessor of said central processing storage unit, comprise a test pattern whose expected value is normal status and a test pattern whose expected value is abnormal status and includes a test pattern via which an abnormal operation corresponding to an abnormal pattern can be detected; and
a report execution unit that stores a result of the diagnostic test into said line diagnostic device and reads the result from the CPU via said second communication line for reporting a completion of the test operation.

14. A line diagnostic method comprising the steps of:
sending and receiving information on a controlled object via a second communication line;
sending and receiving a signal for mediating a usage right of the second communication line via a first communication line;
monitoring a signal sent via the first communication line for checking for an abnormality in a mediation unit; and
if an abnormality is detected in said mediation unit, outputting a signal for suppressing a communication via the second communication line.

15. A line diagnostic method comprising the steps of:
monitoring a signal sent and received via a first communication line to mediate a usage right of a second communication line;
checking for an abnormality based on the monitoring; and
if an abnormality is detected in a mediation unit, outputting a signal for suppressing a communication via the second communication line.

16. A line diagnostic program causing an operation unit to:
monitor a signal sent and received via a first communication line to mediate a usage right of a second communication line;
check for an abnormality based on the monitoring; and
if an abnormality is detected in a mediation unit, output a signal for suppressing a communication via the second communication line.

17. A bus system in which one or more masters and a plurality of slaves are connected to a bus via bus switches for transferring data between said masters and said slaves, said bus system comprising:
a first data transfer period specification unit provided in said master for specifying a transfer period of first data; and
a switch control unit that, in case that the transfer period of the first data is specified, sets the bus switches, corresponding to the master and the slave between which the first data is transferred, to ON and, sets the bus switches , corresponding to the master and the slave (not related to the transfer of the first data, to OFF.

18. The bus system according to claim 17 wherein the transfer of the first data is a transfer of data to which priority higher than priority of other transfer data should be given.

19. The bus system according to claim 17 wherein the transfer of the first data is a transfer of data necessary for maintaining a safety operation of a target system.

20. The bus system according to claim 17 wherein the first data is data related to a basic function of a target system and the other transfer data is data related to an auxiliary function the target system.

21. The bus system according to claim 17, further comprising first data transfer target setting unit that sets, in advance, the master and the slave between which the first data is transferred.

22. The bus system according to claim 17 wherein, in response to a request to start the transfer of the first data, the transfer period of the first data is specified.

23. The bus system according to claim 17, further comprising:
a bus arbiter that mediates transfer requests from a plurality of masters for giving a grant for a usage right of said bus; and
an address decoder that decodes a transfer destination address, wherein
said switch control unit is configured in such a way that, during the transfer period of the first data, said bus switch (corresponding to a transfer source master and said bus switch corresponding to the slave, to which the first data is transferred based on a result of decoding by said address decoder, are set to ON and, all bus switches corresponding to the other master and the slave are set to OFF.

24. The bus system according to claim 17 wherein said switch control unit is configured in such a way that all said bus switches are set to ON in a period other than the period specified by said first data transfer period specification unit as the transfer period of the first data.

25. The bus system according to claim 17, further comprising:
data registers which are provided respectively in said masters and said slaves and to and from which data can be written and read;
a switch diagnosis unit that outputs a diagnostic mode signal, which indicates the diagnosis of said bus switches in case that, to said switch control unit;
a diagnostic mode register provided in said switch diagnosis unit for determining whether or not a mode is the diagnostic mode;
a register access unit that writes to and reads from said data registers; and
an OFF sticking condition diagnostic unit that, during a period in which a content of said diagnostic mode register indicates the diagnostic mode, sets all said bus switches to ON, causes said register access unit to write data in the data registers and, after that, reads the data, and checks if the read data matches the write data.

26. The bus system according to claim 17, further comprising:
data registers which are provided respectively in said masters and said slaves and to and from which data can be written and read;
a switch diagnosis unit that outputs a diagnostic mode signal, which indicates the diagnosis of said bus switches in case that, to said switch control unit;
a diagnostic mode register provided in said switch diagnosis unit for determining whether or not a mode is the diagnostic mode;
a register access unit that writes to and reads from said data registers; and
an ON sticking condition diagnostic unit that, during a period in which a content of said diagnostic mode register indicates a second diagnostic mode, sets all said bus switches to OFF, causes said register access unit to write data in the data registers and, after that, reads the data, and checks if the read data does not match the write data or if arbitrary data is read.

27. The bus system according to claim 17 wherein said bus switches are configured by transistor cells such as MOS switches, selectors, and tri-state buffers.

28. A bus system in which one or more masters and a plurality of slaves are connected to a bus via bus switches for transferring data between said masters and said slaves, said bus system comprising:
a first data transfer period specification unit provided in said master for specifying a transfer period of first data related to a basic function of a target system; and
a switch control unit that, in case that the transfer period of the first data is specified, sets the bus switches in case that, corresponding to the master and the slave between which the first data is transferred, to ON, sets the bus switches, corresponding to the master and the slave between which second data related to an auxiliary function of the target system is transferred, to OFF and, sets the bus switches corresponding to all masters and slaves to ON in case that the transfer period of the first data is not specified.

29. A bus system for use in a power generation plant, comprising:
a power generation plant;
a plant control unit that controls the power generation plant;
a bus connected to the plant control unit via a bus switch;
an I/O control unit connected to the bus via a bus switch;
an I/O device connected to the I/O control unit to control said power generation plant;
a control monitor that monitors and displays an operation status of said power generation plant; and
a display control unit connected to said bus via a bus switch to control the control monitor,
said bus system further comprising:
a control data transfer period specification unit that specifies a transfer period of control data related to the operation control of said power generation plant; and
a switch control unit that, in case that the transfer period of the control data is specified, sets said bus switches in case that, corresponding to said plant control unit and said I/O control unit between which the control data is transferred, to ON, sets said bus switch, corresponding to said display control unit to which data related to an operation status monitor function of said power generation plant is transferred, to OFF and, in case that the transfer period of the control data is not specified, sets the bus switches in case that, corresponding to said plant control unit in case that, said I/O control unit, and said display control unit, to ON.

30. A bus system mounted on a car, comprising:
a car;
an engine ECU that is an electronic control unit for controlling an engine of the car;
an accelerator I/O device connected to the engine ECU via a bus;
steering ECUs that control a steering of said car;
a steering I/O device connected to said bus to control the steering ECUs;
brake ECUs that control a brake of said car;
a brake I/O device connected to said bus to control the brake ECUs; and
bus switches inserted between the ECUs and the I/O devices, said bus system further comprising:
a switch control unit that, in case that control data related to the brakes is transferred, sets said bus switches, corresponding to said brake I/O device and said brake ECUs and to said steering I/O device and said steering ECUs, to ON, and sets said bus switches, corresponding to said accelerator I/O device and said engine ECU, to OFF and, in case that the brake control data is not transferred, sets said bus switches, corresponding to all said ECUs and all said I/O devices, to ON.

31. A bus system for use in a mobile phone, comprising:
a mobile phone;
a telephone processing unit for controlling a telephone call of the mobile phone;
a communication bus connected to the telephone processing unit via bus switch;
a voice input unit connected to the communication bus via a bus switch and connected to a microphone of said mobile phone;
a music function unit connected to said communication bus in said mobile phone via a bus switch for reproducing music based on music data stored in a storage medium in said mobile phone; and
a television function unit connected to said communication bus in said mobile phone via a bus switch for reproducing television images, received from an external source, on a monitor in said mobile phone, said bus system further comprising:
a switch control unit that, in case that a telephone call related to said mobile phone is made, sets said bus switches in case that, corresponding to said telephone processing unit and said voice input unit, to ON and sets said bus switches, corresponding to said music function unit and said television function unit, to OFF and, in case that the telephone call is not made, sets said bus switches in case that, corresponding to all said telephone processing unit, said voice input unit, said music function unit, and said television function unit, to ON.

32. A bus system control method for use in a bus system in which one or more masters and a plurality of slaves are connected to a bus via bus switches for transferring data between said masters and said slaves, said bus system control method comprising the steps of:
specifying a transfer period of first data; and
in case that the transfer period of the first data is specified, setting said bus switches, corresponding to the master and the slave between which the first data is transferred, to ON and, setting said bus switches, corresponding to the master and the slave between which data other than the first data is transferred, to OFF.

33. The bus system control method according to claim 32, further comprising the step of starting the transfer period of the first data in response to a transfer start request of the first data.

34. The bus system control method according to claim 32 wherein the transfer of the first data is given priority higher than priority given to other transfer data.

35. The bus system control method according to claim 32 wherein the transfer of the first data is a transfer of data necessary for maintaining a safety operation of a target system.

36. The bus system control method according to claim 32 wherein the first data is data related to a basic function of a target system and other transfer data is data related to an auxiliary function of a target system.
